(19) United States
(12) Patent Application Publication
(10) Pub. No.: US 2011/0093539 A1
(43) Pub. Date: Apr. 21, 2011

(54) System And Method For Innovation And Idea Management

(75) Inventors: Andre Paul Cyrille Laurin, Point-Claire (CA); Karrell Serge Jean Ste-Marie, La Salle (CA)

(73) Assignee: BRAINBANK, INC., Dorval (CA)

(21) Appl. No.: 12/845,875

(22) Filed: Jul. 29, 2010

Related U.S. Application Data
(60) Provisional application No. 61/230,027, filed on Jul. 30, 2009.

(51) Int. Cl. G06F 15/16

(52) U.S. Cl. 709/205

(57) ABSTRACT

A computer-base system provides a structural environment for innovation and idea management within an organization. Communities of users within the organization and/or other communities of external users may interact with the system via browser-based user interfaces. Each submitted idea or request for ideas is assigned a facilitator who is responsible for performing tasks designed to advance the idea within the organization. The system tracks performance of these tasks and provides information, such as a list of experts available to consult in relation to an idea or task.

### CROSS REFERENCE TO RELATED APPLICATIONS

This application claims the benefit of U.S. Provisional Patent Application No. 61/230,027, filed Jul. 30, 2009, titled “System and Method for Innovation and Idea Management,” the entire contents of which are hereby incorporated by reference herein, for all purposes.

### TECHNICAL FIELD

The present invention relates to innovation and idea management, and more particularly to a structured environment for innovation and idea management.

### BACKGROUND ART

The concept of a “suggestion box” has existed for decades for soliciting and collecting ideas. Submitted ideas may relate to products (such as suggestions for new products, features, packaging, advertising, etc.), processes (improvements to production methods, organizational efficiency, communication, etc.), or any other aspect of an organization or its products, services or operation. However, organizations have found it difficult to implement processes for managing submitted ideas. For example, idea submitters often are not in a position to implement their ideas. Consequently, many valuable ideas are never implemented.

Although systems exist for managing workflows within organizations, and various methods have been proposed for solving problems by harnessing intellectual contributions from large and small groups of people (“crowdsourcing,” “enterprise social software,” “ideas banks” and “innovation management,” including systems available from Spigit.com, such as InnovationSpigit, EnterpriseSpigit and ContestSpigit), deficiencies in these systems and methods exist.

### SUMMARY OF EMBODIMENTS

Illustrative embodiments of the present invention are directed to a computer-implemented method for providing a structured environment for innovation and idea management in an organization. The method includes receiving an idea submission from a submitter and storing the idea submission. The idea submission includes a description of an idea. The idea submission is web-published to at least one member of a user community. The member can comment on the idea submission. The comments are received, stored, and web-published so that members can view them. The method also includes storing, in association with the idea submission, a link to an identifier of a person serving as a facilitator in relation to the idea. The facilitator has editing privileges of the idea submission. The idea submission and a series of tasks associated with advancing the idea in the organization are web-published to the facilitator. The facilitator can edit the idea submission to complete the tasks. Data pertaining to completion of each task in the series of tasks is stored. Both the idea submission and data pertaining to the completion of the tasks is web-published to at least one manager.

Exemplary embodiments of the present invention are directed to a computer-implemented method of vetting an idea submission. The method includes receiving and storing an idea submission from a submitter. The idea submission includes a description for an idea. The idea submission is web-published to a vetter. At least one template is presented to the vetter, which provides the vetter with an opportunity to select, from a list, a scenario for web-publication of the idea submission. The list includes: a) web-publication of the idea to at least one member in a user community; b) withholding web-publication of the idea to at least one member of the community. Other illustrative embodiments may also include the following scenarios: c) web-publication of the idea to members that are both internal and external to the organization; d) withholding web-publication of the idea to members of the community members external to the organization; e) web-publication of the idea to at least one manager; and f) withholding web-publication of the idea to members of the community that are exclusive of the at least one manager. A response to the template is received from the vetter and the idea submission is processed in accordance with the response.

Illustrative embodiments of the invention are directed to a computer-implemented method of limiting pending idea submissions. The method includes web-publishing a limit on the number of pending idea submissions to members of a user community. A plurality of idea submissions are received from the members. A computer process tracks the number of pending idea submissions by each of the members. If a specific member's number of pending idea submissions has reached a pre-designated proximity of the limit, an alert is web-published to the specific member.

Various embodiments of the present invention are directed to a computer-implemented method of collaboration. The method includes receiving an idea submission from a submitter and storing the idea submission. The idea submission includes a description of an idea. The method further includes receiving a request for collaboration for the idea from a facilitator, a vetter, or at least one manager. The request includes identity information identifying at least one member of a user community with whom collaboration is requested. The idea and the request are web-published to the at least one member. The request includes a set of templates through which the at least one member can comment on the idea. In some embodiments, one or more requests are received and web-published so as to develop an idea team.

Exemplary embodiments of the present invention are directed to a computer-implemented method for clustering ideas. The method includes receiving and storing a first idea submission and a second idea submission. The method further includes receiving a set of member selections made on a set of templates to cause association of the first and second idea submissions. In response, a computer process associates the first and second idea submission. The method also includes receiving and storing first information related to the first idea submission and updating the second idea submission with the first information. The updated second idea submission is then web-published.

Illustrative embodiments of the invention are directed to a computer-implemented method for configuring a workflow. The method includes web-publishing at least one template that presents an administrator or a manager with an opportunity to select a scenario for workflow of an idea submission. The list of scenarios includes: a) web-publication of the idea submission to at least one member of a user community for collaboration; b) web-publication and assignment of the idea submission to a vetter for vetting; and c) web-publication and assignment of the idea to a facilitator for advancing the idea in the organization. A response to the template is received from the manager or the administrator. When an idea submission is received, it is processed in accordance with the response to the template.

Various embodiments of the present invention are directed to a computer-implemented method for configuration of webpage templates related to idea submission. The method includes storing a plurality of web page templates related to idea submission. A set of the web pages templates are web-published to an administrator and the administrator is provided with an interface for configuring the set of web page templates. The configured set of web page templates are then web-published to at least one member of a user community.

Exemplary embodiments of the present invention are directed to a computer-implemented method of confirming completion of implementation of an idea. The method includes receiving and storing an idea submission. The idea submission includes a description for an idea. A first set of templates is web-published to a facilitator or a manager. The first set of templates present the facilitator or the manager with an opportunity to select an implementation deadline for the idea. A response to the set of templates including the implementation deadline for the idea is received. Based upon the implementation deadline, a second set of templates requesting confirmation that the idea has been executed is automatically web-published to an implementer.

In any of the above described embodiments, a listing of subject matter experts may be web-published to the facilitator. Additionally or alternatively, a set of cost data from a cost database may be web-published to the facilitator. Furthermore, in various embodiments, a set of templates through which the facilitator can enter a set of values to calculate cost information for the idea may be web-published to the facilitator. Additionally, in some embodiments, the facilitator can import cost information into the idea submission. In another additional or alternative embodiment, a computer process may convert cost data from one currency to another.

In further specific embodiments of the above described methods, comments are web-published to the facilitator and a designation of at least one favorable comment is received from the facilitator via web page interaction. The designation of the at least one favorable comment is then web-published to a set of members. Furthermore, in some embodiments, the facilitator is internal to the organization. While, in other embodiments, the facilitator is external to the organization.

In other specific embodiments of the above described methods, a designation is received from a facilitator. The designation signifies that a task associated with advancing the idea in an organization is complete. The designation is web-published to the members of a user community.

In another embodiment, a scoring template associated with the facilitator, is web-published to a set of members of the user community. Scoring data from the second set of members obtained via web page interaction with the scoring template is received and the scoring data is web-published to a set of managers.

In any of the above described embodiments a search for similar idea submissions in a database of previously submitted idea submissions is automatically performed. Additionally or alternatively, points may be awarded to a member of the community by triggering any one of: a) receipt of an idea submission; b) receipt of a comment; c) completion of a task associated with advancing the idea in the organization; d) acceptance of an idea; and e) implementation of an idea submission. Furthermore, additionally or alternatively, a budget of rewards for the submitted idea may be stored and web-published to a facilitator. Also, a set of templates, wherein the facilitator may allocate rewards to certain members, is web-published to the facilitator. An allocation of rewards to the members is stored.

Also, in various embodiments of the above described methods, the idea may be web-published in at least one of eWork and Second Life. Furthermore, in some embodiments, an announcement may be web-published to members of the user community. In other embodiments, a set of templates through which the facilitator can enter implementation information for the idea is web-published to the facilitator. In further illustrative embodiments, a set of templates through which the facilitator can import a spreadsheet for the idea is web-published to the facilitator. In another exemplary embodiment, a set of templates through which the facilitator can designate a source of funding for implementation of the idea is web-published to the facilitator.

In some or all of the embodiments described above, a set of templates may be web-published to members of a user community. The members can enter competitor related information through the templates. The competitor related information is received and web-published to the members of the user community. In various illustrative embodiments, a set of statements that promote development of an idea are web-published to the user community. In another exemplary embodiment, a timeline for an idea submission is web-published to members of a user community. The timeline includes at least a date of submission for the idea submission. In additional or alternative embodiments, a visual graphic showing progress of a plurality of idea submissions through a workflow is web-published to members of a user community.

### BRIEF DESCRIPTION OF THE DRAWINGS

The foregoing features of the invention will be more readily understood by reference to the following detailed description, taken with reference to the accompanying drawings, in which:

FIG. 1 shows a system providing a structured environment for innovation and idea management in an organization, in accordance with one embodiment of the present invention;

FIG. 2A is a block diagram representing a logical structure for the system, in accordance with one embodiment of the present invention;

FIG. 2B is a block diagram representing a data structure for the system, in accordance with one embodiment of the present invention;

FIG. 3A is a block diagram representing a logging process for the system, in accordance with one embodiment of the present invention;

FIG. 3B is a flow diagram representing a method for responding to a member action, in accordance with one embodiment of the present invention;

FIG. 4 is a representation of a web page permitting acceptance of terms in a term of use agreement, in accordance with one embodiment of the present invention;

FIG. 5A is a representation of a web page permitting entry of information related to an idea, in accordance with one embodiment of the present invention;

FIG. 5B is a representation of an automated search, in accordance with one embodiment of the present invention;

FIG. 6 is a representation of a web page permitting further entry of information related to the idea, in accordance with one embodiment of the present invention;

FIG. 7 is a representation of a web page permitting submission of the idea, in accordance with one embodiment of the present invention;

FIG. 8 is a representation of a web page displaying a plurality of challenges, in accordance with one embodiment of the present invention;

FIG. 9 is a representation of a web page permitting vetting of the idea, in accordance with one embodiment of the present invention;

FIG. 10 is a representation of a web page displaying information related to the idea, in accordance with one embodiment of the present invention;

FIG. 11 is a representation of a web page displaying information related to a plurality of ideas, in accordance with one embodiment of the present invention;

FIG. 12 is a representation of a web page permitting a member to designate himself as a facilitator for the idea, in accordance with one embodiment of the present invention;

FIG. 13 is a representation of a web page permitting the facilitator to enter description information related to the idea, in accordance with one embodiment of the present invention;

FIG. 14 is a representation of a web page permitting the facilitator to enter benefit information related to the idea, in accordance with one embodiment of the present invention;

FIG. 15 is a representation of a web page permitting the facilitator to enter implementation information related to the idea, in accordance with one embodiment of the present invention;

FIG. 16 is a representation of a web page permitting the facilitator to enter financial information related to the idea, in accordance with one embodiment of the present invention;

FIG. 17A is a representation of a web page permitting the facilitator to access a cost database, in accordance with one embodiment of the present invention;

FIG. 17B is a representation of a web page permitting the facilitator to calculate costs, in accordance with one embodiment of the present invention;

FIG. 17C is a representation of a web page displaying the cost information, in accordance with one embodiment of the present invention;

FIG. 18 is a representation of a web page permitting the facilitator to import a spreadsheet, in accordance with one embodiment of the present invention;

FIG. 19 is a representation of a web page permitting the facilitator to attach files related to the idea, in accordance with one embodiment of the present invention;

FIG. 20 is a representation of a web page displaying a comment, in accordance with one embodiment of the present invention;

FIG. 21 is a representation of a web page displaying a comment that has been designated as favorable by the facilitator, in accordance with one embodiment of the present invention;

FIG. 22 is a flow diagram representing a computer-implemented method providing a structured environment for innovation and idea management in an organization, in accordance with one embodiment of the present invention;

FIG. 23 is a representation of a web page displaying a plurality of tools available to the facilitator, in accordance with one embodiment of the present invention;

FIG. 24 is another representation of a web page displaying a plurality of tools available to the facilitator, in accordance with one embodiment of the present invention;

FIG. 25 is a representation of a web page displaying a request for collaboration, in accordance with one embodiment of the present invention;

FIG. 26 is a representation of a web page permitting the facilitator to request collaboration, in accordance with one embodiment of the present invention;

FIG. 27 is another representation of a web page permitting the facilitator to request collaboration, in accordance with one embodiment of the present invention;

FIG. 28 is a representation of a web page permitting the facilitator to select an idea team, in accordance with one embodiment of the present invention;

FIG. 29 is a representation of a web page permitting the facilitator to request information from a subject matter expert, in accordance with one embodiment of the present invention;

FIG. 30 is a representation of a web page permitting a manager to vote on the idea, in accordance with one embodiment of the present invention;

FIG. 31 is a representation of a web page permitting review and accept the idea for implementation, in accordance with one embodiment of the present invention;

FIG. 32 is a representation of a web page permitting the manager to enter information related to implementation of the idea, in accordance with one embodiment of the invention;

FIG. 33 is a representation of a web page permitting entry and calculation of cost and/or benefits related to the idea, in accordance with one embodiment of the invention;

FIG. 33 is a representation of a web page permitting entry and calculation of benefits related to the idea, in accordance with one embodiment of the invention;

FIG. 34 is a representation of a web page permitting simulation of financial data, in accordance with one embodiment of the invention;

FIG. 35 is another representation of a web page permitting entry of information related to implementation of the idea, in accordance with one embodiment of the invention;

FIG. 36 is a representation of a web page permitting entry of information related to funding of the idea, in accordance with one embodiment of the invention;

FIG. 37 is a representation of a web page that summarizes voting results for a plurality of ideas, in accordance with one embodiment of the invention;

FIG. 38 is a representation of a web page permitting an implementer to commit to implementation of the idea, in accordance with one embodiment of the invention;

FIG. 39 is a representation of a web page permitting a party to set rewards for the idea, in accordance with one embodiment of the invention;

FIG. 40 is a representation of a web page allowing a member to redeem his points, in accordance with one embodiment of the invention;

FIG. 41 is a representation of a web page permitting an implementer to confirm that implementation is complete, in accordance with one embodiment of the invention;

FIGS. 42-45 represent examples of workflows, in accordance with one embodiment of the invention;

FIG. 46 is a representation of an interface for editing web page templates, in accordance with one embodiment of the invention;

FIG. 47 is a representation of a web page displaying a listing of a plurality of web page templates, in accordance with one embodiment of the invention;

FIG. 48 is a representation of a competitive watch web page permitting a member to enter information related to competitors, in accordance with one embodiment of the invention;

FIG. 49 is a representation of a web page displaying progress of a plurality of ideas through a workflow, in accordance with one embodiment of the invention;

FIG. 50 is a representation of a web page displaying announcements, in accordance with one embodiment of the present invention; and

FIG. 51 is a representation of a web page displaying a facilitator profile, in accordance with one embodiment of the present invention.

### DETAILED DESCRIPTION OF SPECIFIC EMBODIMENTS

Definitions. As used in this description and the accompanying claims, the following terms shall have the meanings indicated, unless the context otherwise requires:

An “organization” may be any group of people organized for some end purpose. The organization may be a for-profit business or company, but, it may also be a non-profit entity, such as a charity. Examples of organizations include corporations, partnerships, social networks, and clubs.

A “user community” is a group of people who have access to a network, such as the Internet. In some embodiments of the present invention, a user community can be as broad as anyone who has access to the Internet. In other embodiments, the user community is more specific. For example, the user community may include any member who has registered with a particular Internet social network, such as Facebook® or MySpace®. In some cases, the user community includes active members. In other words, the members participate in the network through posting comments and information. In other cases, the user community may be more passive. For example, the user community includes anyone who views or reads a particular website.

An “idea” can be any thought, conception, or notion that can be expressed using words, optionally in combination with a graphical image. The idea may relate to a new product, process, method, or advertisement. In some cases, the idea may relate to a solution of a particular problem and/or a more efficient way of doing something. The idea may be an advertisement, a design, a packaging, a product, a prospective employee to hire and/or a particular problem with no proposed solution. In some cases, the idea may be a complaint, and development of the complaint may result in another idea that resolves the complaint. Ideas may relate to inter alia:

| | |
|---|---|
| Improving the quality or client/patient | Improving or streaming |
| satisfaction. | procedures. |
| Avoiding duplication of effort. | Producing additional revenue. |
| Enhancing employee relationships to. | Generating cost savings. |
| Improving workplace health and safety. | |

A “submitter” is a person who submits an idea or a representative of a team of people who collectively submit the idea. In some cases, the submitter is not the person who conceived of the idea.

An “idea submission” is data (including words and optionally a graphical image) that is submitted that characterizes the idea (e.g., a description, a title, a benefit, a file, a spreadsheet, a comment, and a request for collaboration).

A “vetter” is a person who decides whether an idea is appropriate for further development.

A “facilitator” is a person who is responsible for advancing (or championing) an idea through an organization.

A “subject matter expert” is a person who has expertise in a particular field.

A “manager” is a person in an organization who decides, makes decisions including whether to implement an idea. “Management” includes at least one manager.

An “implementer” is a person who is responsible for making use of an idea and/or putting the idea into effect. For example, the implementer may be responsible for developing and manufacturing a new product based on an idea.

“Web-publishing” means publishing information, also known as “content” in the form of a web page, over a network, to at least one person using a browser. The web page may optionally be accessed via a link in an e-mail message. Web-publishing includes publishing a web page template that allows a person to enter text and/or upload other information. The web page template may include: radio buttons, check boxes, entry windows, mouse-over events, and/or activation buttons (e.g., submit, cancel, next, previous, etc. buttons) to facilitate data entry, designation, and/or navigation.

“Collaboration” involves web-publishing an idea to at least one member of a user community.

An “administrator” is a person who has editing privileges of web pages.

A “task” is an action that is performed to advance an idea through an organization or through a process. A task may include sub-tasks. Examples of tasks include: deciding whether an idea is appropriate for further development (e.g., vetting); and acting as a facilitator for an idea, which may include a performing number of other tasks.

“Assignment” means to charge a particular person with performing at least one task.

“Web page interaction” means to enter or designate information using a web page. For example, web page interaction may include selection of an icon (e.g., a radio button) or entry of textual information into an entry window in a web page.

A “workflow” is a sequence of tasks associated with advancing an idea from submission to implementation.

A “set” of objects includes at least one member object.

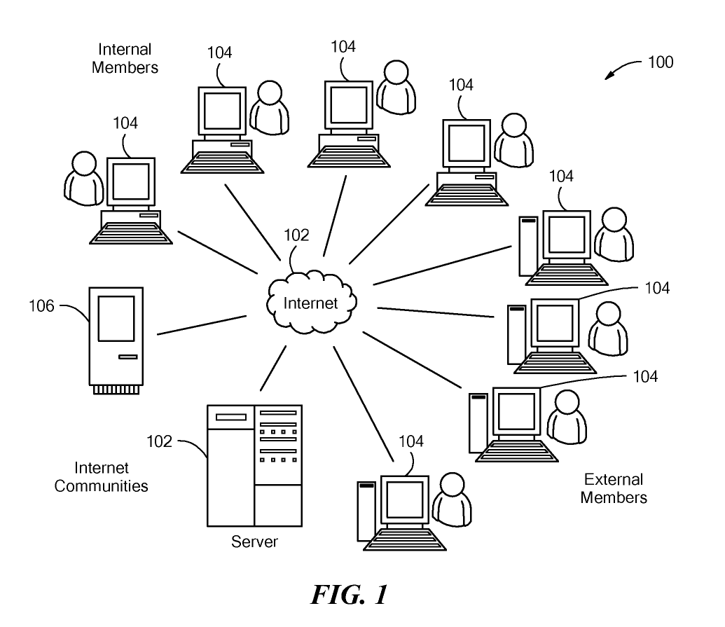

FIG. 1 is a schematic block diagram of a system 100 for providing a structured environment for innovation and idea management in an organization, in accordance with an exemplary embodiment of the present invention. The system includes a server 102 that is in communication with a computer network, such as the Internet 103. The server 102 typically includes a computer processor that is programmed to support a website, i.e., to serve at least one web page. Individual members of a user community may use their respective terminal 104 (e.g., desk-top computers, lap-tops, and smart phones, such as a BlackBerry®) to communicate with the server 102 via the computer network 103. The website may be accessed and displayed by the terminals 104 over the network 103. Furthermore, the terminals 104 may send information back to the server 102 over the computer network 103. In some embodiments, information may come from the terminals 104 in a number of different forms. For example, in one embodiment, the communication may come as digitized sound from a cellular phone. In another embodiment, the members of the user community may dictate submissions and/or comments via telephone. In various embodiments of the present invention, the user community may include only members that are internal to the organization (e.g., employees, trusted advisors, and partners). In other embodiments, the user community consists of members that are external to the organization (e.g., academia, social networks, suppliers, professional associations, shareholders, subject matter experts, customers, and consumer groups). In still further embodiments, the user community may include members that are both internal and external to the organization.

In illustrative embodiments of the present invention, the server 102 is also in communication with one or more Internet communities implemented by one or more servers, represented by server 106. For example, the server 102 may be in communication with servers that implement Internet communities Facebook®, ePost®, Second Life® and the like.

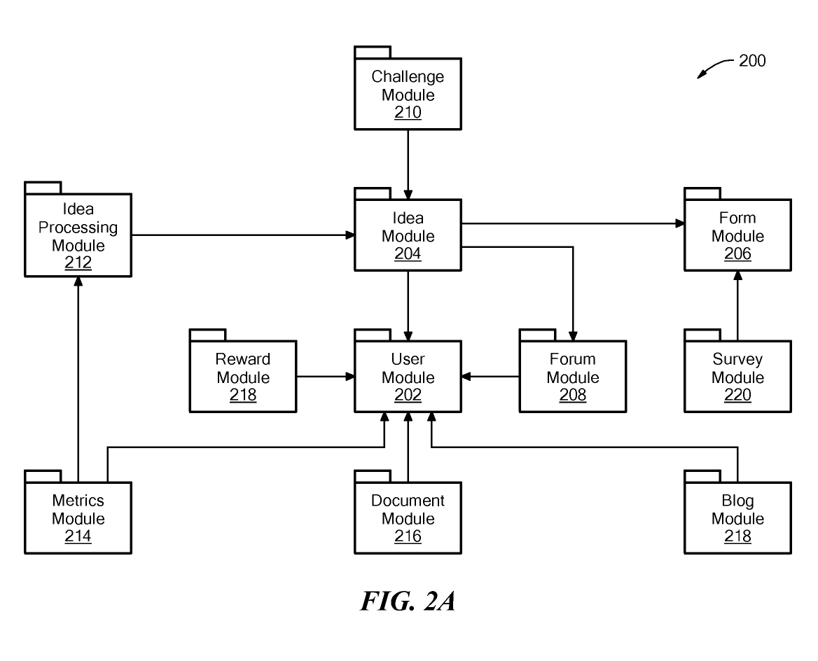

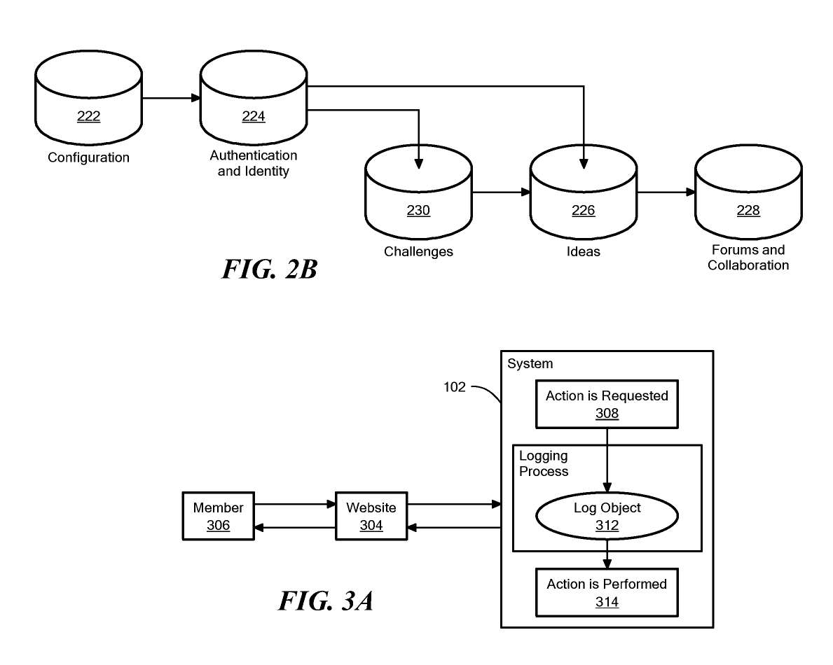

FIG. 2A is a schematic block diagram representing a set of modules for the system, in accordance with one embodiment of the present invention. The system 200 includes a user module 202 that enables the system to track the owner of an action (e.g., a task). An idea module 204 receives and stores idea submissions and information related to the submissions (e.g., title, description, and benefits). The idea module 204 also communicates with other modules to provide the other modules with requested information. For example, if the member requests to see all of his pending idea submissions, the user module 202 receives the request and communicates with the idea module 204 to request data representing all the idea submissions associated with the member.

A form module 206 receives and stores webpage templates. The form module 206 also determines which templates are used to respond to member requests (e.g., which web templates are web-published) and provides them to other modules. For example, the idea module 202 may request the form module 206 to provide it with a web-page template for web-publishing benefits in relation to an idea submission and/or a webpage template for entry of benefits in relation to the idea submission.

A forum subsystem module 208 facilitates communication between members of the user community through, for example, comments and requests for collaboration. The forum module 208 stores the communication in relation to a particular idea submission and provides the communication to other modules. A challenges module 210 receives and stores challenges. The challenges module 210 also determines which challenges information to provide to the idea module 204, in relation to a particular idea submission. An idea processing module 212 registers assignment and completion of tasks for a particular idea submission. The idea processing module 212 communicates with the idea module 204 and determines, for example, whether the idea can progress in the workflow, based on whether a particular set of tasks has been completed. Furthermore, the idea processing module 212 tracks and stores data that indicates which tasks have been completed. A metrics module 214 stores and provides metrics related to performance of the system (e.g., total number of idea submissions, number of ideas implemented, and number of ideas approved). A document module 216 stores attached documents and provides the documents to other modules in relation to a particular idea submission. A reward module 216 keeps track of rewards in relation to particular members and communicates reward information to the user module 202. In some embodiments, the system 200 may include a blog module 218 and/or a subsystem module 220. These modules, 218, 220, respectively, store and provide blog and survey information.

FIG. 2B is a schematic block diagram of databases used in the system 100, in accordance with an embodiment of the present invention. A configuration database 222 stores instructions and rules on how the system should respond to a particular request by a member and/or to the completion of a particular set of tasks. For example, the configuration database 222 may store rights for particular members (e.g., the information the members can access). An authentication and identity database 224 stores identity information (e.g., e-mail address, IP address, username, password, and/or home address) for the members of the community. An ideas database 226 stores information related to ideas submissions (e.g., title, description, and benefits). Each idea submission in the ideas database 226 is associated with one or more members in the authentication database 224. For example, an idea submission may be associated with a submitter, a vetter, and/or a facilitator in the authentication database 224. Idea submissions in the ideas database 226 are also associated with data in a forums and collaboration database 228. The forums and collaboration database 228 stores communications, such as comments and requests for collaboration. Each idea submission in the ideas database 226 may be associated with, for example, comments that are related to the idea submission. Exemplary embodiments of the present invention may also include a challenges database 230 that stores challenge information. Each challenge also has associated data in the authentication database 224 (e.g., associated member who posted the challenge) and forums databases 228 (e.g., associated title, description, and benefits). In alternative embodiments, the challenge information may be stored in the ideas database 226.

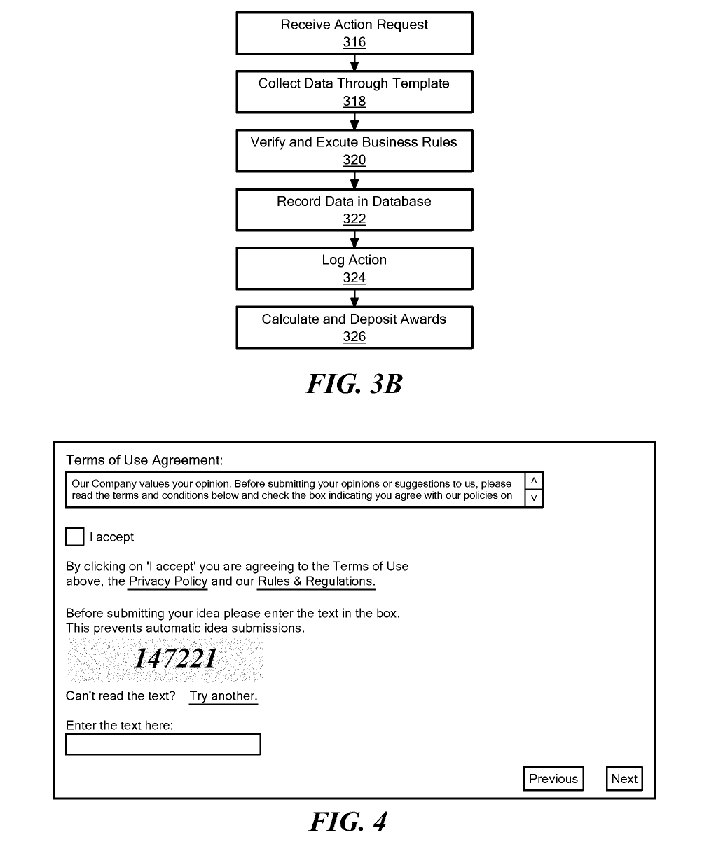

FIG. 3A is a schematic block diagram representing a logging process for the server 102 (FIG. 1), in accordance with an embodiment of the present invention. As noted, the server 102 supports a website 304 with which a member 306 can interact. When interacting with the website 304, the member 306 can request a particular action 308. For example, an action could be, inter alia, submitting of an idea, commenting on an idea, logging into the system, voting on an idea, completing a task, and/or responding to a challenge. In any event, the action invokes a logging process 310, wherein a log object 312 logs the action. The log object 312 is a modular piece of code that logs the request 308 and saves it to a database. For example, if the member submits a description for a particular idea submission, the log object logs the submission and saves it to, for example, the ideas database 226. The log object 312 may log the request by assigning inter alia a date for the request, timestamp for the request, the member that submitted the request, and/or the related idea submission. In some embodiments, once the action is logged, the action may be performed 314 and results or status web-published on the website 304.

FIG. 3B is a flow diagram representing operations performed to respond to an action, in accordance with an embodiment of the present invention. At 316, the action is requested, such as by a member submitting an idea, commenting on an idea, completing a task, logging into the system, voting on an idea, responding to a challenge, etc. At 318, the system receives user input data from the member through a web page template of the website. At 320, the system verifies whether the requested action is permitted, according to business rules for the system 100. A business rule is one or more conditions that must be met for an action to be permitted. For example, if a facilitator submits an idea to management (but the facilitator has not completed all of her assigned tasks) and a business rule requires that the facilitator complete all of her assigned tasks before submission, then the business rule would cause the submission to be rejected. In this case, the system may web-publish a message informing the facilitator that she must complete all of her tasks before she can submit the idea. If, however, the facilitator has completed all of the required tasks, the system may accept the submission. In either case (e.g., acceptance or rejection), the submission is recorded 322 (at least temporarily) into a database and the action is logged (as in, for example, FIG. 3A) 324. In some embodiments, at 326, the system 100 may also calculate and deposit a reward based on member action.

Appendix A attached hereto includes a unified modeling language description of a set of objects for implementing the system 100, in accordance with an embodiment of the present invention. The Appendix includes exemplary embodiments of:

An idea system—foundation framework object

A forum system—foundation framework object

A task system object

An idea subscription system object

A status history object

A status change—data access layer object

A status change—foundation framework

An idea search system object

An idea tools—foundation framework object

A cost DB data access layer object

A system features object

A system data store—foundation framework object

A form provider—custom forms object

A form validator—foundation framework object

A logger system object

A challenge system—foundation framework object

A challenge—business logic object

A tracker system object

A user system—data access layer object

A user system—business layer and rules object

A profile/identity system object

A reward system—business layer and rules object

A reward module—application structures object

A reward module—application entities object

An RSS feeds object

A resource editor object

A reporting—chart object

A notification system—revision 1 object

A notification system—revision 2 object

A social bookmarks object

A security system object

A blog system object

An idea ranking system object

A mail setting object

A SMTP mail bridge object

An E-mail unique code generator object

An avatar system object

A bad word filter object—application entities object

A bad word filter object—business layer object

Illustrative embodiments of the present invention begin one set of operations upon receipt of an idea submission by a submitter who is a member of the user community. FIG. 4 is a representation of a web page by which a user may accept certain terms and conditions (collectively hereinafter “terms”). Before the idea is submitted, the system may require that the submitter agree to the terms. For example, the system may require that the submitter agree to assign all intellectual property rights in the idea to the organization. In the embodiment of FIG. 4, the submitter can check a box to confirm that he agrees to the terms.

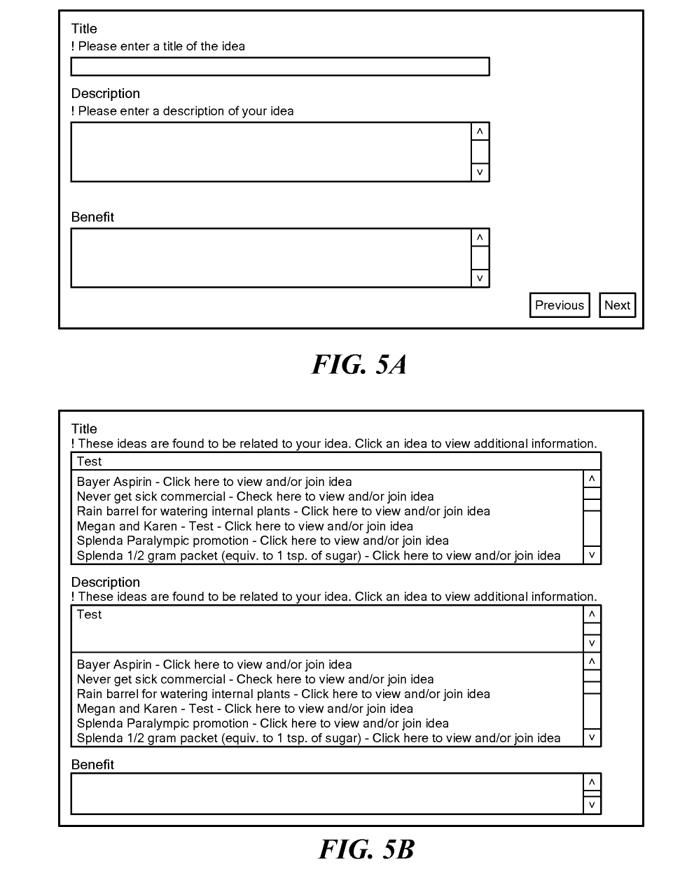

Once the submitter agrees to the terms, in some embodiments, the next step involves the submitter entering a description of the idea. FIG. 5A is a representation of a web page permitting entry of information related to the idea. The submitter may enter a title of the idea and a description of the idea into respective entry fields. Entering text into the “Title” and “Description” fields are examples of performing tasks. Completion of these tasks helps advance the idea through the workflow. As shown in FIG. 5A, there may also be a “Benefit” field, into which the submitter may enter text describing the benefits of the idea. For example, the submitter may describe how his idea promotes efficiency, reduces redundancies, or results in costs-savings. In other embodiments, the web page may include fields for entering other information, such as, inter alia:

Department or division affected by the idea

Name of the submitter (or other submitters if submitting on behalf of a team)

A problem that should be solved

A problem that is solved by the submitted idea

Recurrence frequency of the problem

A solution to the problem

Expected costs of the solution

Improvements in quality control, cycle time, and/or service expected as a result of solving the problem or implementing the idea

In some embodiments, the title field and/or the description field may include an automated search feature. FIG. 5B shows results of a hypothetical automated search in accordance with an embodiment of the present invention. As the submitter enters text into the title or description field, the system automatically searches one or more of the databases 222-230 (FIG. 2) for previously submitted ideas that are related to and/or match the entered text. In various embodiments of the present invention, the automated search feature includes a natural language search engine. Illustrative embodiments of the automated search help the submitter avoid submitting ideas that have previously been submitted or that have already been addressed.

Some embodiments of the present invention accept files or links to files that help explain and/or describe the idea. For example, a submitter can upload video, sound, image, and/or document files. In some embodiments, the submitter can enter a URL, such as a link to a particular web page (e.g., a link to a YouTube® video clip.

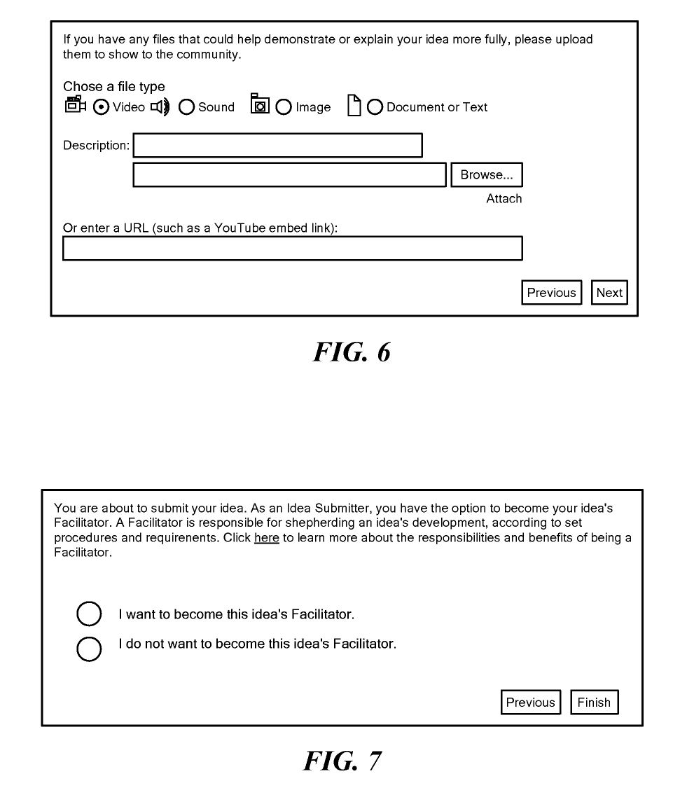

FIG. 6 illustrates a web page configured to upload such files or accept such URLS. In some embodiments of the invention, the submitter can elect to become a facilitator for the idea. FIG. 7 illustrate a web page through which an idea submitter can choose whether to become a facilitator for his submitted idea.

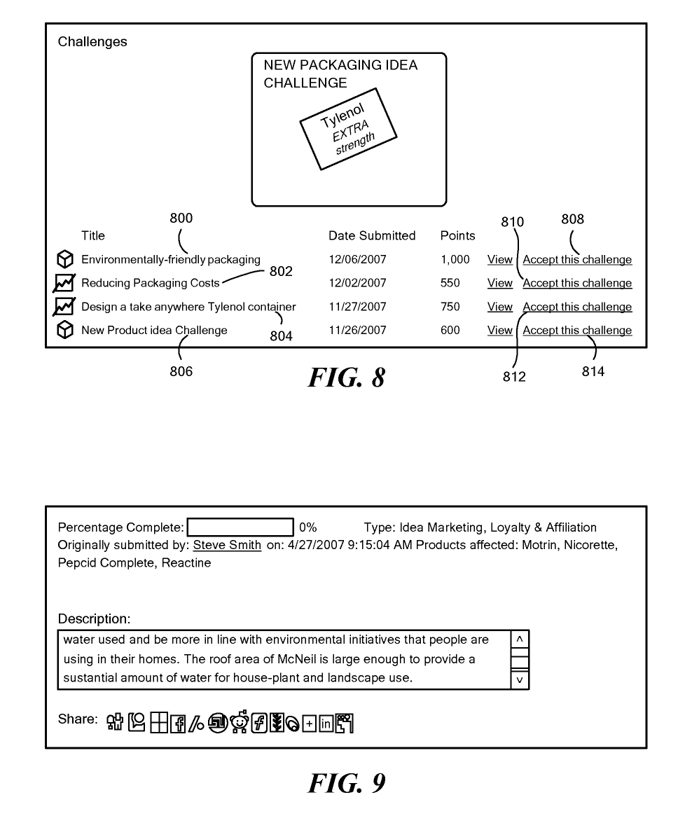

In some embodiments, a member of the user community, such as a manager, can submit an idea in the form of a challenge. As noted, a challenge presents a problem and requests that a member of the user community solve the problem. FIG. 8 illustrates a web page displaying a plurality hypothetical of challenges 800, 802, 804 and 806, along with corresponding links 808, 810, 812 and 814, which may be involved to accept any of the challenges 800-806. The exemplary challenges listed in FIG. 8 include designing a new portable container and designing environmentally friendly packaging. When a member accepts a particular challenge, he becomes a facilitator for the challenge.

In illustrative embodiments of the present invention, once the submitter submits an idea, the idea is assigned to a vetter for vetting. The vetter may be automatically assigned by the system, or the vetter may be assigned by management based on, for example, his expertise and experience, and the subject matter of the idea. FIG. 9 is a representation of a web page displaying a description of a hypothetical idea to the vetter so he can decide whether the idea is appropriate. In some contexts, some ideas, such as the following ideas, may be considered inappropriate. However, in other contexts, some or all of these ideas may be considered appropriate.

Ideas: Ideas will be considered ineligible if they Are already targeted
for implementetion, as evidenced by written documentation.

| | |
|---|---|
| Recommend the elimination of a specific individual. | Do not conform to legal or regulatory guidelines. |
| Call for the reduction of employee wages and/or benefits. | Duplicate previously submitted ideas, as evidence by |
| | written documentation. |
| Are already in use at the location for which the change is proposed. | Have apparent savings that would actually reduce |
| | revenues. |
| Reduce the quality or satisfaction levels of products and service | Recommend changes to the content of corporate |
| provided to our patents or clients. | advertising or media selection. |
| Concern community involvement or charitable contributions. | |

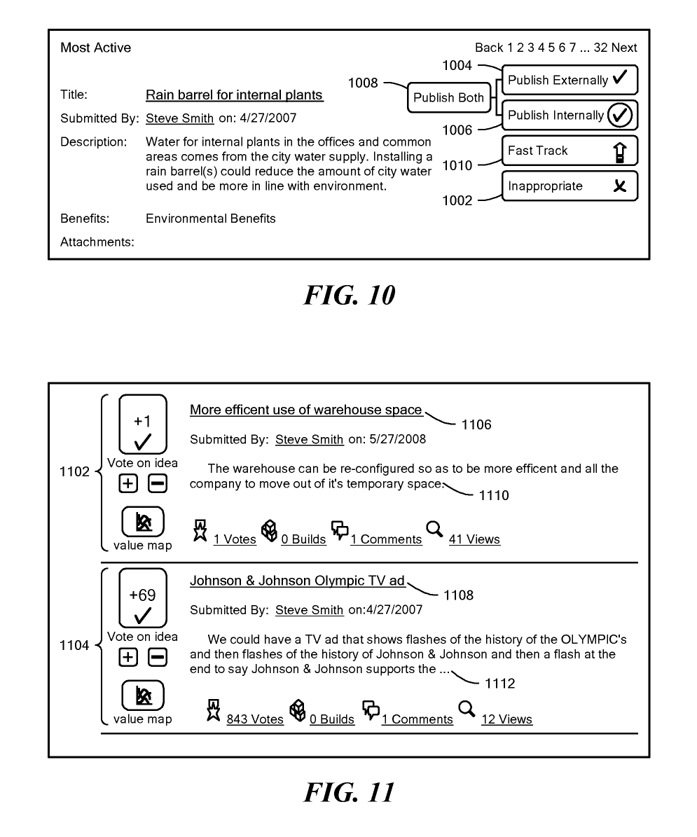

FIG. 10 is a representation of a web page that facilitates vetting of an idea. Vetting is another example of a task. If the vetter decides that the idea is inappropriate, he may select the “Inappropriate” button 1002 with his cursor. The system also presents the vetter with a number of web-publication options 1004, 1006 and 1008. If the idea is appropriate, the vetter can select one of these options 1004-1008 to publish the idea. A “Publish Externally” button 1004 allows the vetter to web-publish the idea to only members of the user community that are external to the organization. In this manner, the organization can receive comments from the public. A “Publish Internally” button 1006 allows the vetter to web-publish the idea to only members of the user community that are internal to the organization. Thus, ideas that are confidential are not disclosed to the public. By selecting a “Both” button 1008, the idea is web-published to both external and internal members of the user community. In some embodiments, the vetter can select a “Fast Track” button 1010. If this option 1010 is selected, the idea is assigned to management for review and/or approval for implementation. This mechanism allows the best ideas to be forwarded directly to management, optionally bypassing certain steps and/or eliminating the need for certain tasks to be performed before the idea is accepted. In some embodiments, when the idea is fast tracked, it is only web-published to management due the valuable nature of the idea. Whichever option 1002-1010 the vetter chooses, the system stores the vetter's selection, and the vetter's task is deemed to be complete.

After vetting, the idea is web-published to members of the user community, according to the vetter's selection 1004-1008. FIG. 11 is a representation of a web page displaying a listing of two hypothetical ideas 1102 and 1104. The listings provide the title 1106 and 1108 and description 1110 and 1112 for each idea. In the embodiment shown, a member can provide a comment for the idea. The comment is web-published and associated with the idea so that other members can review the comment. The embodiment shown also allows members to vote on the idea. The listing provides a tally (e.g., score) for the votes. The positive numbers show that there are more positive votes than negative votes for each of the ideas. The voting tool helps the organization (e.g., management) quickly locate the most popular ideas.

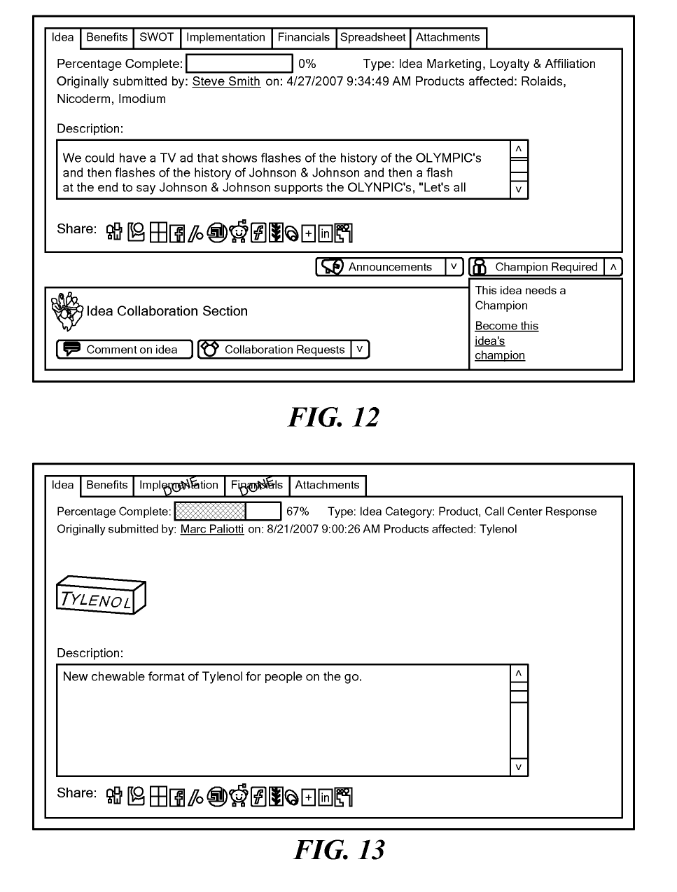

By clicking on the title of the idea, the member can view more details about the idea. For example, the member can view comments associated with the idea. FIG. 12 is a representation of a web page permitting the member to view further details of the idea. In the embodiment shown in FIG. 12, the member can click on tabs to view information about the benefits of the idea, the financial information for the idea, and/or the implementation of the idea. The detailed view also includes a percentage completion graphical display. In some embodiments, this graphical display is based on the number of tasks that must be completed before the idea can be submitted to management for approval. In another embodiment, this graphical display is based on the number of tasks that must be completed before the idea is implemented.

In cases where the submitter did not assign himself as a facilitator, a member of the user community can assign himself as the facilitator for the idea. FIG. 12 shows a “Champion” button that allows a member to designate himself as a facilitator for the idea. In other embodiments of the invention, however, management assigns the facilitator for the idea and members of the user community do not have the option to assign themselves as facilitators.

FIG. 13 is a representation of a web page permitting the facilitator to enter description information related to the idea. The facilitator has editing privileges for the idea so that he can update and add information to the web page entry windows. In this case again, the entry windows are representative of tasks that are completed to advance the idea. By entering the description information into the field, the facilitator completes the task and the data in the entry window pertains to completion of the task. In this case, when all of the entry windows for a particular tab are completed, the facilitator, or in other embodiments, the system itself, can designate the tabs as “done.” In the embodiment shown, for example, all of the entry windows in the documentation and financials tabs are complete and thus, the tabs are designated as “done.” Furthermore, because many of the tasks are complete, the percentage completion graphical display indicates that idea is 67% complete.

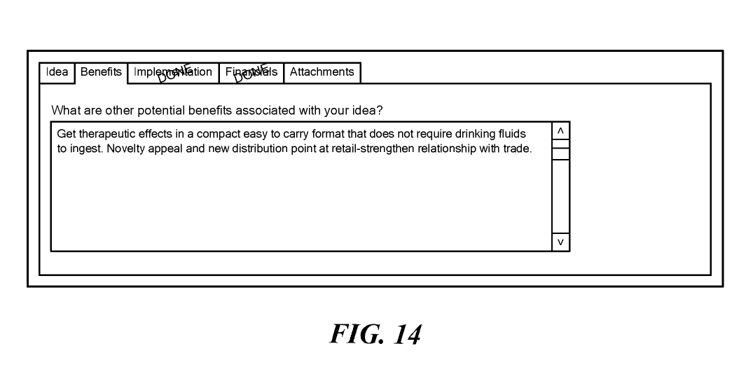

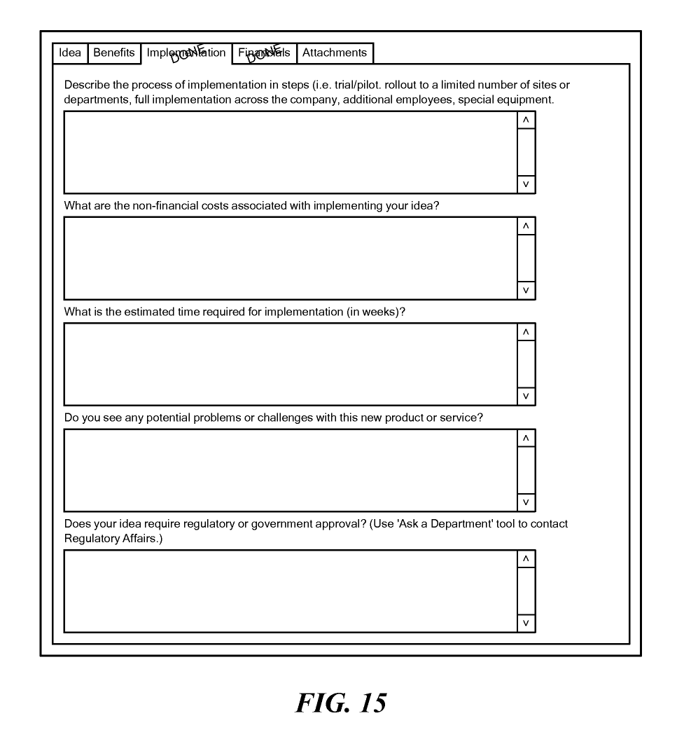

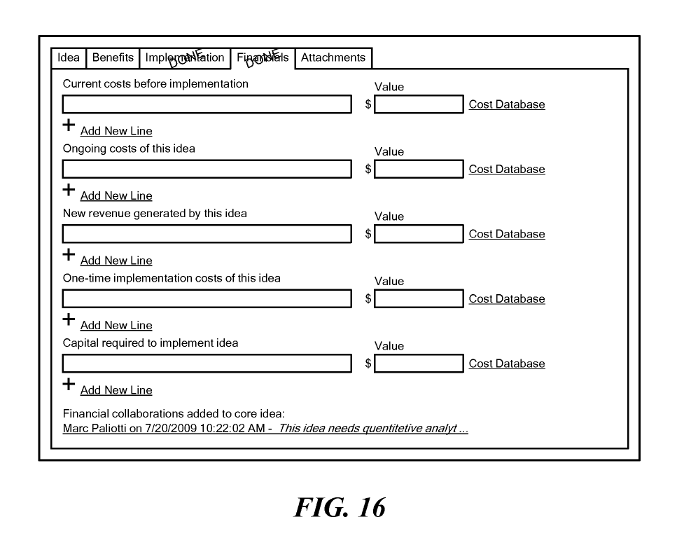

As explained above, the facilitator can select the different tabs with his cursor and edit and add information in the web page entry windows. FIG. 14 is a representation of a web page that permits the facilitator to enter benefit information related to the idea. FIG. 15 is a representation of a web page that permits the facilitator to enter implementation information related to the idea. For example, an “Implementation” tab may require that the facilitator describe the steps necessary to implement the idea, the non-financial costs of implementing the idea, the time required to implement the idea, the problems the implementers may encounter, and/or any government or regulatory approval that may be required. FIG. 16 is a representation of a web page permitting the facilitator to enter financial data related to the idea. This “Financials” tab may require the facilitator to enter cost information such as the costs before implementation of the idea, the ongoing costs of the idea, implementation costs of the idea, and capital required to implement the idea. Furthermore, in some embodiments, the facilitator may be required to enter information on potential revenue generated by the idea.

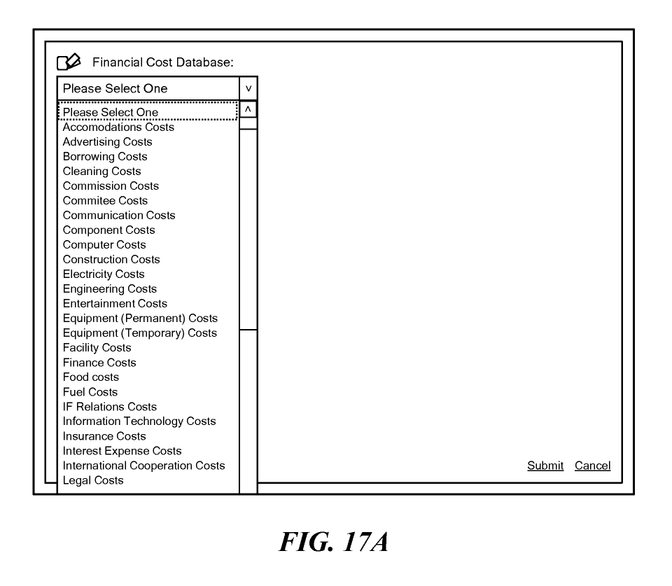

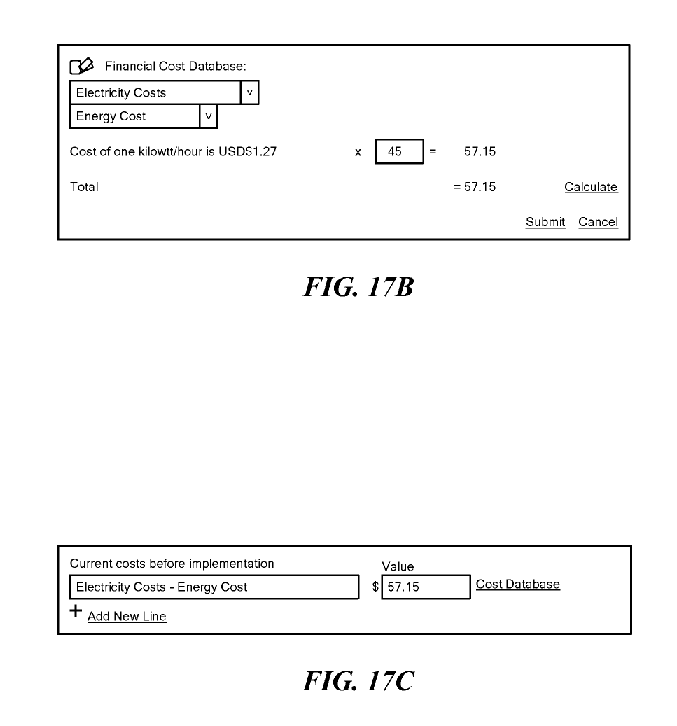

In illustrative embodiments of the invention, the financials tab includes a link to a costs database that helps the facilitator estimate the costs associated with the idea. The costs database includes information for a plurality of different activities and/or utilities. FIG. 17A is a representation of a web page permitting the facilitator to access the cost database. In the embodiment shown, a pull-down menu is used to select from a plurality of different activities. For example, the facilitator may choose from food costs, engineering costs, and electricity costs. The information in the costs database may be populated by the administrator, management, or any other party that is familiar with the organization's revenue and operating information or automatically from an accounting, billing or other system that contains actual cost data from other projects.

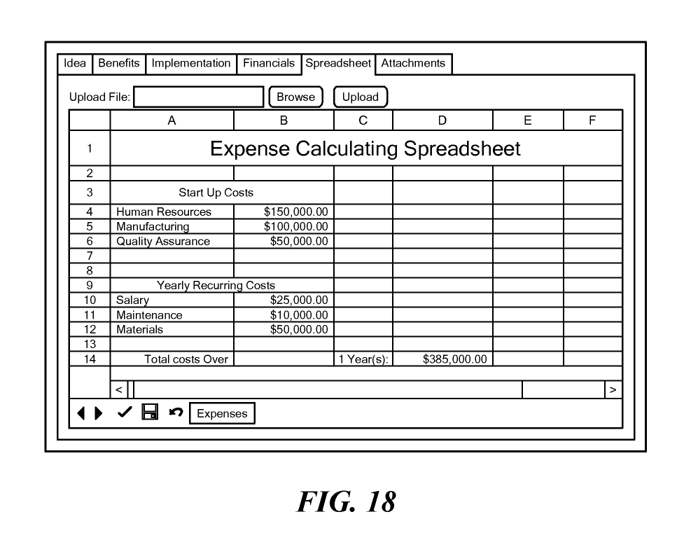

Once the facilitator selects a particular cost, in some embodiments, the selection will link the facilitator to a cost calculator. FIG. 17B is a representation of a cost calculation web page permitting the facilitator to calculate costs. In the embodiment shown, pull down menus in the cost calculation web page also allow the facilitator to switch between different costs. Once the activity/utility cost is selected, the facilitator can enter a value into a “multiplier” entry window. In the embodiment shown, the facilitator can determine electricity costs by entering the number of kilowatt hours the idea will need for implementation. Once the facilitator enters the value into the multiplier field, by selecting the “Calculate” button, he can calculate the total cost for the particular activity/utility. In FIG. 18, the total value for electricity costs will then appear in a “total” field in the cost calculation web page. In some embodiments, the facilitator may import the total cost for the activity/utility into the financials tab. In this manner, the facilitator can link cost data in the cost database to a specific cost entry window in the financial tab. In some cases, the system will also import the label for the activity utility cost. FIG. 17C shows a webpage wherein the activity/utility cost and an appropriate label for the utility/cost have been imported into the financials tab.

An internal facilitator will typically have access to the cost data in the cost database. In some embodiments, however, the external facilitator will not have access to the cost data and/or the information will be censored in some respect. In this manner, confidential revenue and operating information is not disclosed to the public.

In illustrative embodiments of the present invention, the external facilitator will be assigned to complete the “Idea,” “Benefits,” and “Documentation” tabs for the idea. Once those tabs are complete, the idea will be assigned to an internal facilitator who will complete the financial tabs. In some cases, the internal facilitator may also be able to edit the external facilitator's entries.

In illustrative embodiments of the present invention, the facilitator can import and upload spreadsheets into a spreadsheet entry window in a “Spreadsheet” tab as shown in FIG. 18. For example, the facilitator may have previously prepared a spreadsheet in Microsoft Excel® that analyzes the costs associated with the idea. Instead of duplicating his efforts, the facilitator can simply import his work into the spreadsheet entry window.

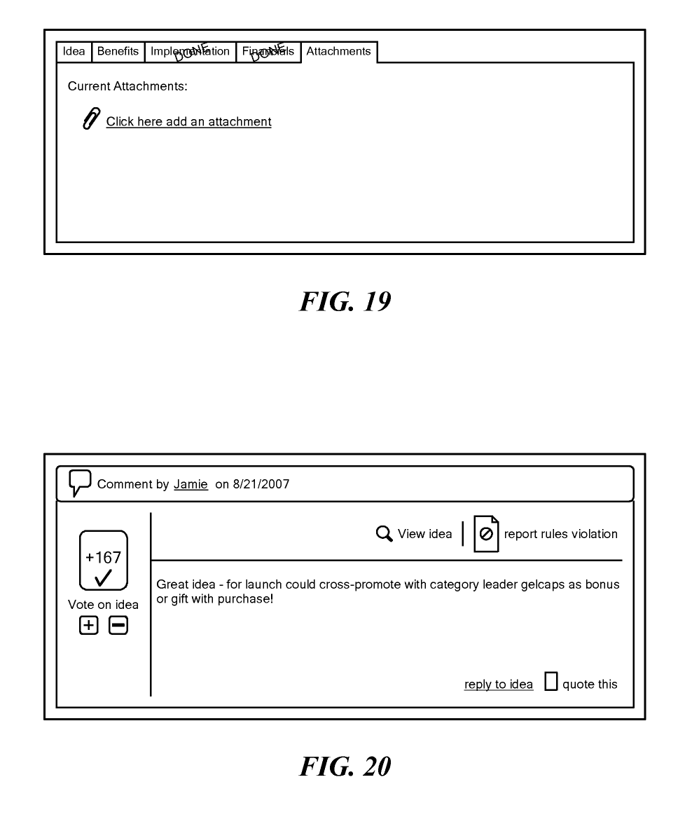

Similarly to the submitter, in some embodiments of the invention, the facilitator may also attach files. FIG. 19 is a representation of an “Attachments” tab permitting the facilitator to attach files related to the idea. In various embodiments, the facilitator can remove or edit files that the submitter attached.

FIG. 20 shows a comment in accordance with one embodiment of the present invention. In this case, a member of the user community has commented that he thinks the idea is great. In some embodiments, the members of the user community can also web-publish the comment with an attached file. In the embodiment shown, other members of the user community can vote on the comment. A positive vote means the other members agree with the comment whereas a negative vote means that they do not agree. In this case, the positive number indicates that there have been 167 more positive votes than negative votes. In this manner, the organization and/or the facilitator can quickly locate the most important and favorable comments.

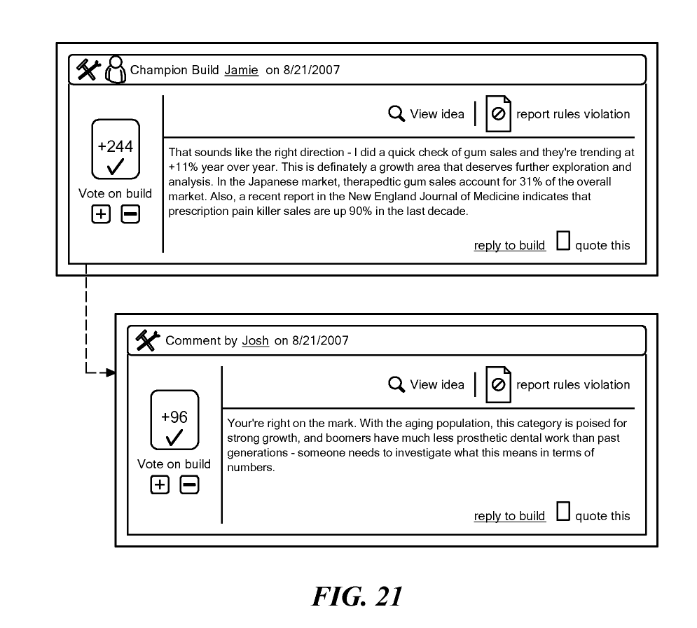

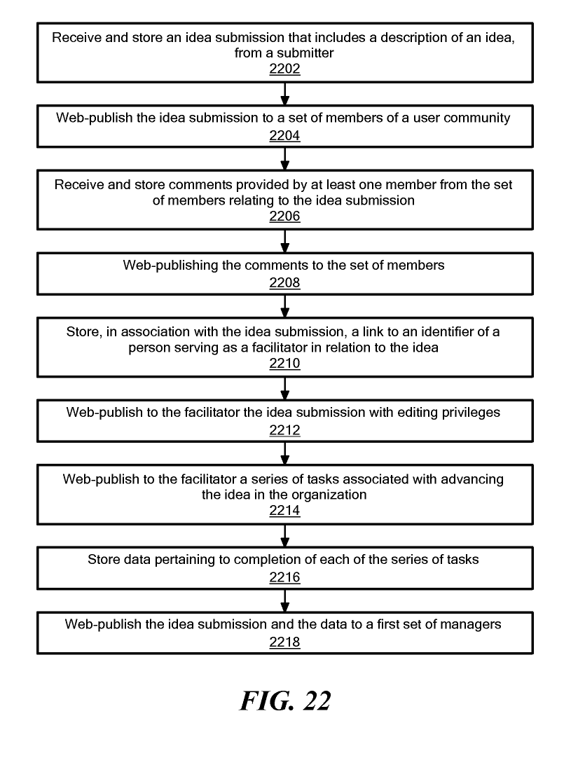

As shown in FIG. 21, illustrative embodiments of the present invention also allow the facilitator to build on a comment. In other words, illustrative embodiments allow the facilitator to designate a comment as favorable and, in some embodiments, allow the facilitator to enter an entry about the comment. In the embodiment shown, “Josh” commented that the idea has potential for growth. The facilitator “Jamie” reviewed Josh's comment and designated it as favorable by building upon Josh's comment. Also, Jamie commented that Josh's comments “sounds like the right direction” and then added further support for Josh's comment. Jamie's entry is labeled “Champion Build” to signify that the facilitator designated a particular comment as favorable. Also, in the embodiment shown, there is a directory hierarchy below the champion build. The champion build allows the facilitator to manage, focus, and lead the direction of idea development. In the future, other members can read the champion build and focus their comments and advice based on the entry in the champion build. In the embodiment shown in FIG. 22, the members may also vote on the champion build.

FIG. 22 is a flow diagram representing a computer-implemented method providing a structured environment for innovation and idea management in an organization. The method includes receiving and storing an idea submission from a submitter over a computer network 2202. The idea submission includes a description of an idea. The idea may be submitted via the webpage presented in, for example, FIG. 5A. Once the idea is submitted, the idea submission is web-published over the network to one or more members of the user community 2204. FIGS. 11 and 12 provide examples of web-published idea submissions. The members of the user community may comment on the idea submission. The system receives and stores the comments 2206. Then, the comments are web-published to the members of the community 2208. An example of a published comment is provided in FIG. 20. The method further includes storing, in association with the idea submission, a link to an identifier of a person serving as a facilitator in relation to the idea 2210. As explained above, the facilitator may be selected by management or, as in FIG. 12, may select himself as the facilitator. In yet another embodiment, the system may automatically select the facilitator based on a set of predetermined parameters or based on a random selection. In exemplary embodiments, the link between the idea submission and the facilitator may be an association between the stored idea submission in the ideas database 226 (of FIG. 2B) and the identifier for the facilitator stored in the authentication database 224. The idea submission is web-published to the facilitator with editing privileges 2012. This means that the facilitator can add and edit information for the idea submission. FIGS. 13-19 show examples of how the facilitator can edit and add information related to benefits, documentation, implementation, and financials for the idea. The method also includes web-publishing to the facilitator a series of tasks associated with advancing the idea in the organization 2014. These tasks include, for example, completing entry windows in the benefits tab, the documentation tab, and the financials tab. Further examples of possible tasks that need to be completed are provided in FIGS. 13-19. As the facilitator enters the information in each entry window, the system stores the information 2216. The presence of information (e.g., textual data) in each entry window signifies that the task associated with each entry window is complete. Therefore, the information in an entry window pertains to the completion of a task associated with the entry window. The data pertaining to completion of tasks is stored by the system in, for example, the ideas database (of FIG. 2B). The idea submission and the information pertaining to the completion of tasks (e.g., information in the entry windows) is web-published to management 2218. In this manner, management can keep track of the idea submission. In some embodiments, management can view the idea submission throughout its entire workflow. However, in other embodiments, management does not see the idea submission until it is assigned to them for review and/or voting.

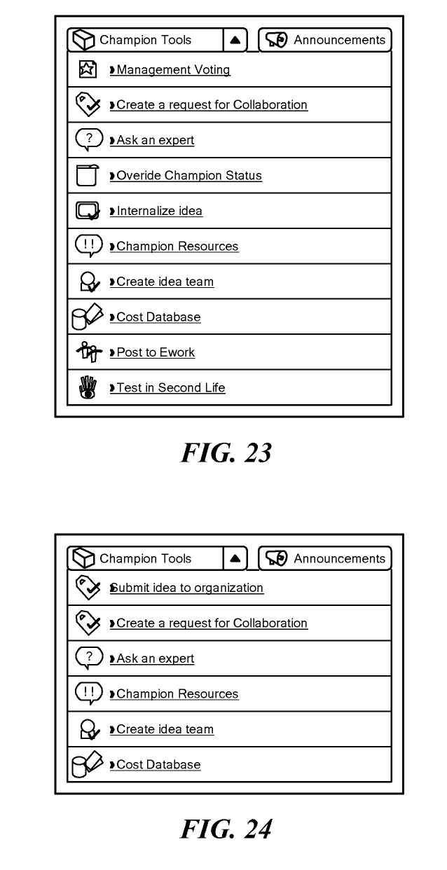

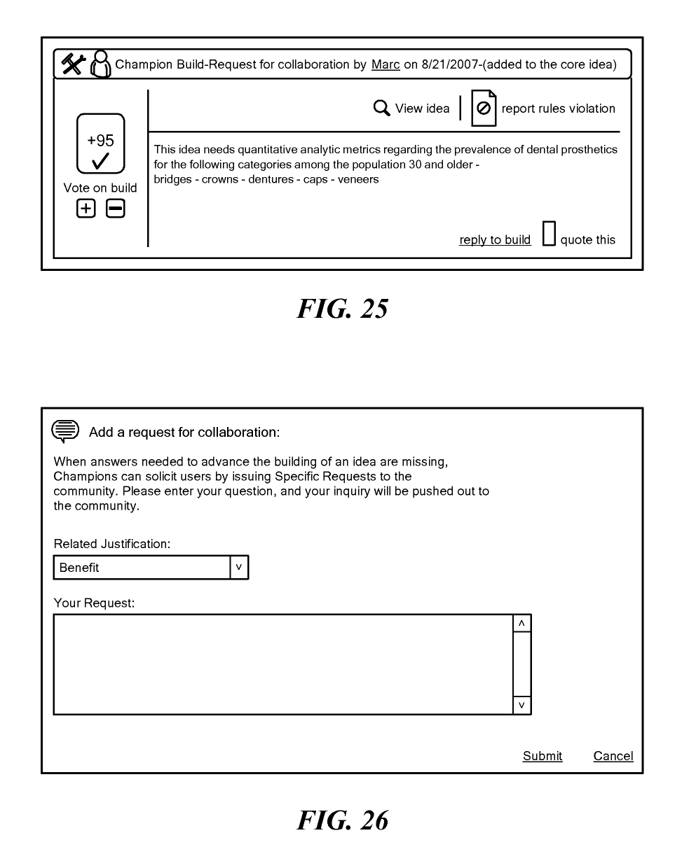

FIGS. 23 and 24 show two different web pages that display a plurality of tools available to the facilitator. One of the tools available to the facilitator is a request for collaboration. FIG. 25 is a representation of a web page displaying the request for collaboration. The request for collaboration is a request by the facilitator for advice and/or help on a particular issue and/or problem. In the embodiment shown, the facilitator is asking for qualitative analytic metrics. Members that read the request can post a response by selecting the “reply to build” button with their cursor and then adding a textual entry that responds to the request. In the embodiment shown in FIG. 25, the members can also vote on the request for collaboration. The facilitator can web-publish his request for collaboration by selecting the request from the champion tools pull-down menu (shown in FIG. 24). In response to this request, the system will web-publish a web page, such as the one shown in FIG. 26, through which the facilitator can enter text describing his request for collaboration. In various embodiments, the facilitator can choose the topic for the request from a pull-down menu. Once the facilitator has entered his request, he can web-publish the request by selecting the “Submit” button.

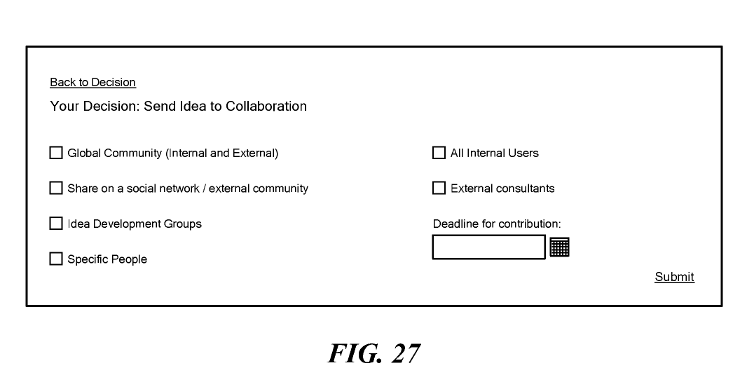

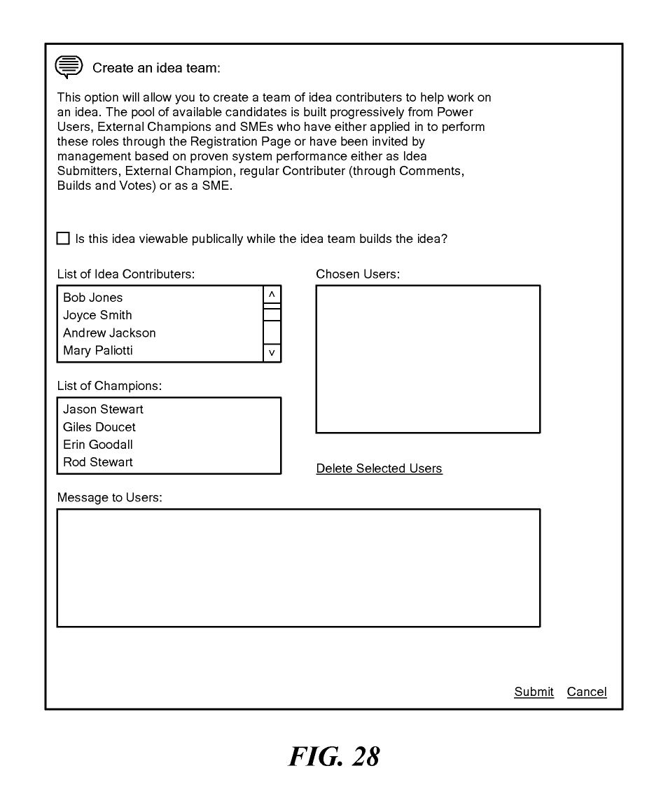

In the embodiment shown in FIG. 26, the request for collaboration is sent to all of the members to whom the idea was initially web-published. In many cases, to be able to respond to the request, the members have access to view the idea. However, in alternative and additional embodiments, the facilitator can choose specific members to whom he would like to web-publish the request. FIG. 27 is an example of a web page that permits the facilitator to choose specific members. The facilitator can select using his cursor the particular members or set of members that should see the request (e.g., internal members only, external consultants, and global community). FIG. 28 a representation of a web page that permits the facilitator to select an idea team. In illustrative embodiments of the present invention, the facilitator can choose a number of specific members to contribute to the idea. The facilitator can message the idea team to ask them their opinion of the idea and/or he may request help with specific problems or issues.

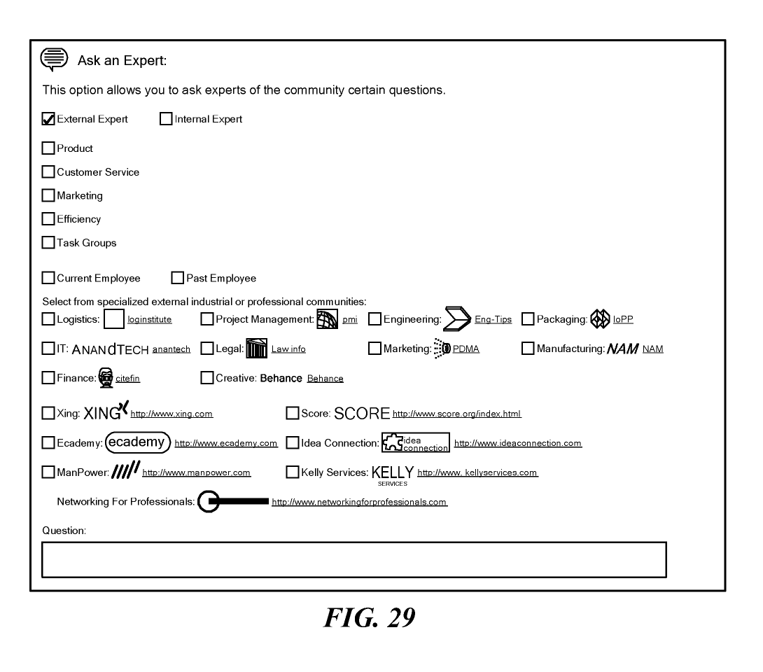

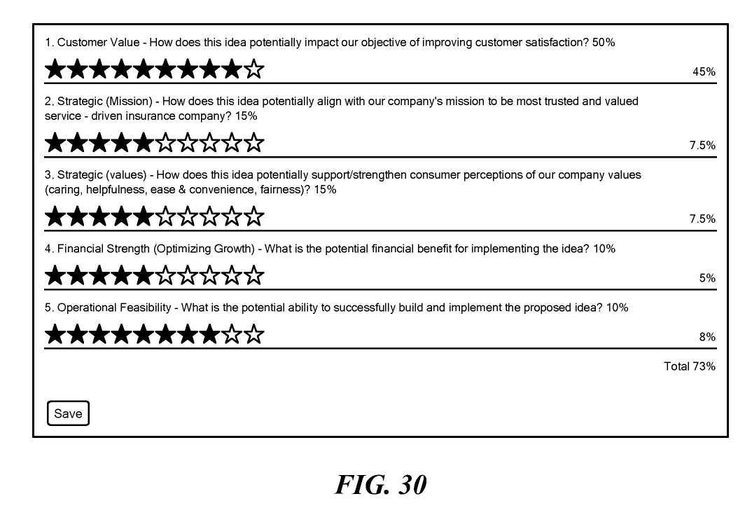

FIG. 29 shows another example of a tool that is available to the facilitator in illustrative embodiments of the present invention. In some embodiments, the facilitator can ask a subject matter expert a question. The web page shown in FIG. 30 allows the facilitator to select one or more expert for his question using check boxes. As can be seen in FIG. 29, the facilitator can choose from a plurality of different experts. The subject matter experts may be internal to the organization (e.g., a mechanical engineer employed by the organization) or external to the organization (e.g., a well-known expert in the field of metallurgy who is self-employed). In various embodiments, the facilitator can also select from a number of external industrial and/or professional communities (e.g., Kelly Services®, Idea Connection®, and Eng-Tips®). The bottom of the web page includes an entry window through which the facilitator can enter his question. Once the facilitator selects the “Submit” button, the question is communicated to the subject matter experts that have been checked off. In this manner, the “Ask a Subject Matter Expert” tool allows the facilitator to select a person that is most likely to have an answer to their technical question, instead of simply web-publishing that question to the user community.

In various embodiments of the present invention, the facilitator can post and/or test the idea in an Internet community, such as eWork® and/or Second Life®. For example, if the idea is a new advertisement, the facilitator can post the advertisement in eWork and/or Second Life to monitor how the members of those communities receive the advertisement. eWork and other Internet communities provide programming interfaces that allow one computer program to interact with another. Illustrative embodiments of the present invention interact with, for example, eWork through its programming interface. In another example, the facilitator may be able to try his idea in Second Life. In this case, similarly, exemplary embodiments of the system interact with Second Life through its programming interface.

As discussed above with respect to FIGS. 23 and 24, posting to eWork and/or Second Life may not be available in certain embodiments of the invention. This may be true for other facilitator tools as well. For example, an external facilitator may not have the option of posting to eWork and/or Second Life, whereas an internal facilitator may have access to those posting tools. The tools that are available to the facilitator may be selected by management and/or the administrator. For example, an internal facilitator may have access to more tools than an external facilitator because, in many cases, the internal facilitator is an employee and has a responsibility to keep the organization's information confidential. To illustrate this point, in an exemplary embodiment, the listing of tools provided in FIG. 23 are available to internal facilitators, whereas the listing of tools in FIG. 24 are available to external facilitators.

In illustrative embodiments of the present invention, where there is both an external facilitator and an internal facilitator, once an external facilitator has completed the tasks assigned to him in relation to the idea (e.g, completing the implementation tab), he may select the “Submit the Idea to Organization” button as shown in FIG. 24. In some embodiments, the idea is then assigned to an internal facilitator who becomes responsible for completing other tasks in relation to the idea (e.g., complete the financials tab of the idea). In other embodiments, however, the idea can be assigned to a manager or a plurality of managers so that they can vote on the idea. FIG. 30 is an example of a web page that permits the manager (or management) to vote on the idea. In some embodiments, the vote may be a simple “Yes” or “No” vote. But, in the embodiment depicted in FIG. 30, the manager can assign a number of stars for a plurality of different categories. The categories include customer value, the organization's mission, the organization's value, financial strength, and operational feasibility for the idea. The more stars the manager assigns to a category, the more favorably the idea aligns with the particular category. Each category may also have a particular scaled weight. For example, in the embodiment depicted in FIG. 30, the customer value category is assigned a scaled weight of 50%. In other words, the customer value category is the most important category and will have the most impact on whether the idea is approved. If the manager assigns 9 stars to the customer value category, the 9 stars translate to a scaled percentage score of 45%. In the embodiment depicted in FIG. 30, the total score based on all the categories in 73%. In various embodiments, management and/or the administrator can set a minimum score for approval at a pre-designated percentage (e.g., 70%). In this case, if the pre-designated percentage is 70%, a score of 73% would approve the idea. Furthermore, if there is more than one manager voting on the idea, then the total score can be averaged to determine whether the idea meets the pre-designated percentage. In another embodiment, the total score can be a composite score from the managers and non-manager members that voted on the idea. The management vote and non-management vote may have different weights attached to their votes.

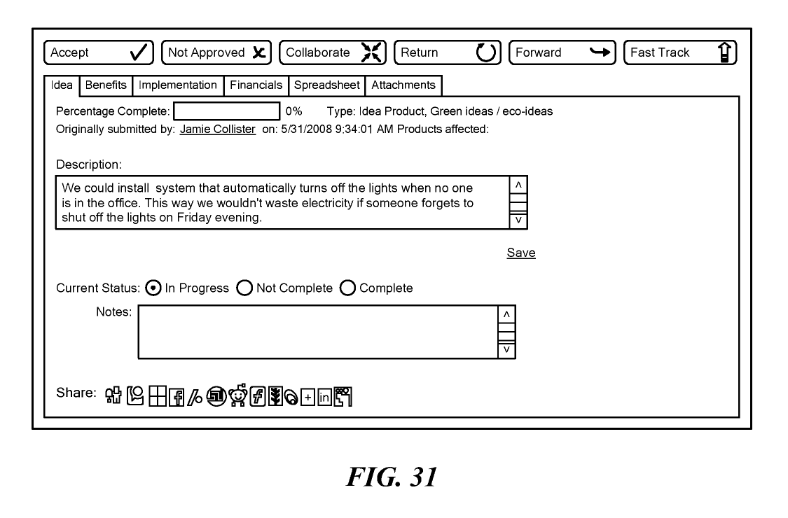

Once management approves the idea, in some embodiments, the idea is assigned to an internal facilitator for further development. In some cases, once the internal facilitator has completed his tasks associated with idea, the idea is once again assigned to management so that management can give the idea final approval for implementation. If the idea is approved, it is assigned to an implementer. However, in other embodiments, there is no internal facilitator and, once the idea is approved by management, it is assigned to the implementer. In yet another embodiment, the facilitator has the authority to approve the idea. FIG. 31 is a representation of a web page permitting the facilitator to review and accept the idea for implementation. The facilitator may submit the idea by selecting the “Accept” button. If, however, the facilitator believes the idea will not be a success, he can reject the idea by selecting the “Not Approved” button. In the embodiment shown in FIG. 31, the facilitator has the ability to forward the idea to another person for comment and evaluation (e.g., subject matter expert and/or internal employee). In some embodiments, the facilitator also has the ability to fast track the idea to management and/or implementation.

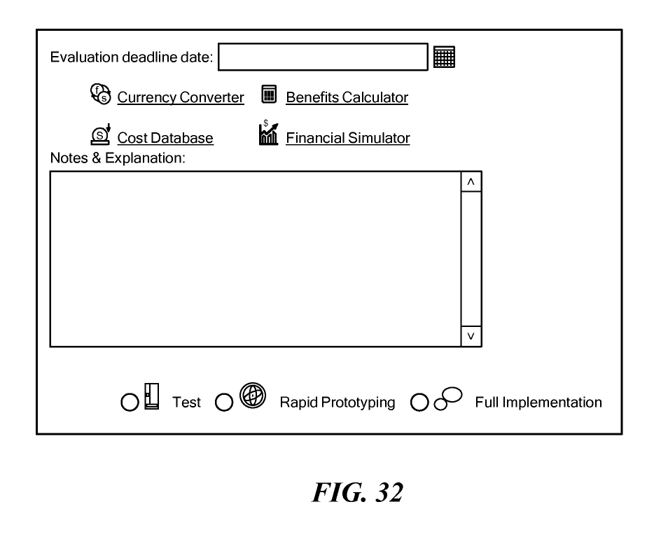

In any event, once the idea is approved by the facilitator and/or management, it is then assigned to an implementer. FIG. 32 is a representation of an implementation web page permitting a manager to enter information related to implementation of the idea. In some embodiments, the entry windows in the web page are completed by a manager, but, in other embodiments, the templates are completed by the facilitator. The implementation web page shown in FIG. 32 allows the manager to select a deadline for evaluation of the idea. In other words, the manager can set a deadline by which the implementer must respond to the implementation request. To do this, the implementer decides whether or not he can implement the idea according to the particular timeline and costs designated by management. The implementation web page also allows the manager to select the type of implementation for the idea. Three radio buttons allow the manager to choose testing the idea, rapid prototyping the idea, or fully implementing the idea (full implementation will typically cost more than a test or rapid prototype of the idea). The implementation web page also includes an entry window for notes and explanations wherein the manager can, for example, describe the rational and/or reasoning for his selection.

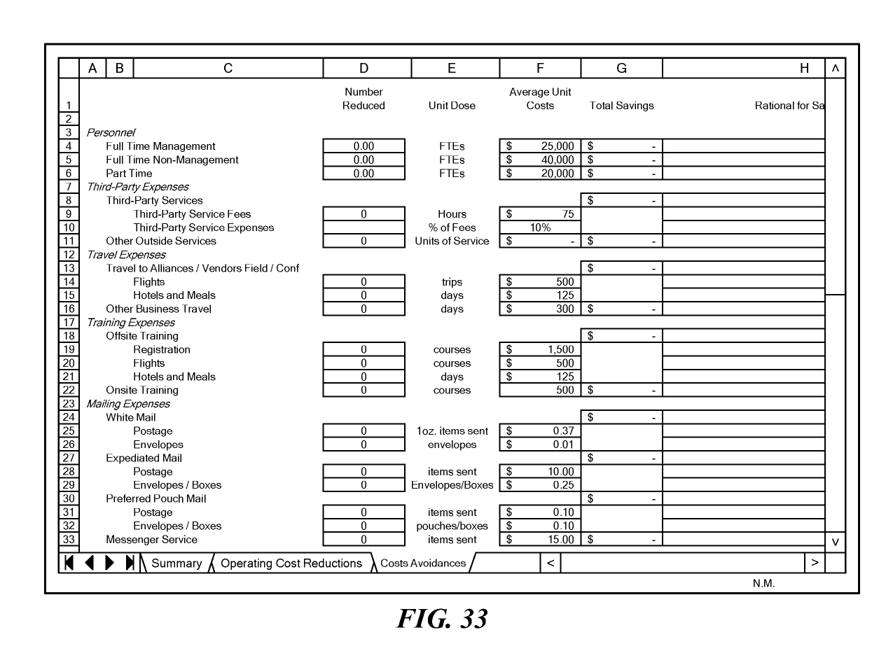

In various embodiments of the present invention, the implementation web page template includes a benefits calculator. FIG. 33 is a representation of a web page permitting the manager to enter and calculate benefits related to the idea. For example, if the idea is a process improvement, the manager can enter the number of hours saved by personnel and the benefits calculator calculates the total savings for the idea. In various embodiments, the benefits calculator includes, among other things, travel expenses, training expenses, and mailing expenses.

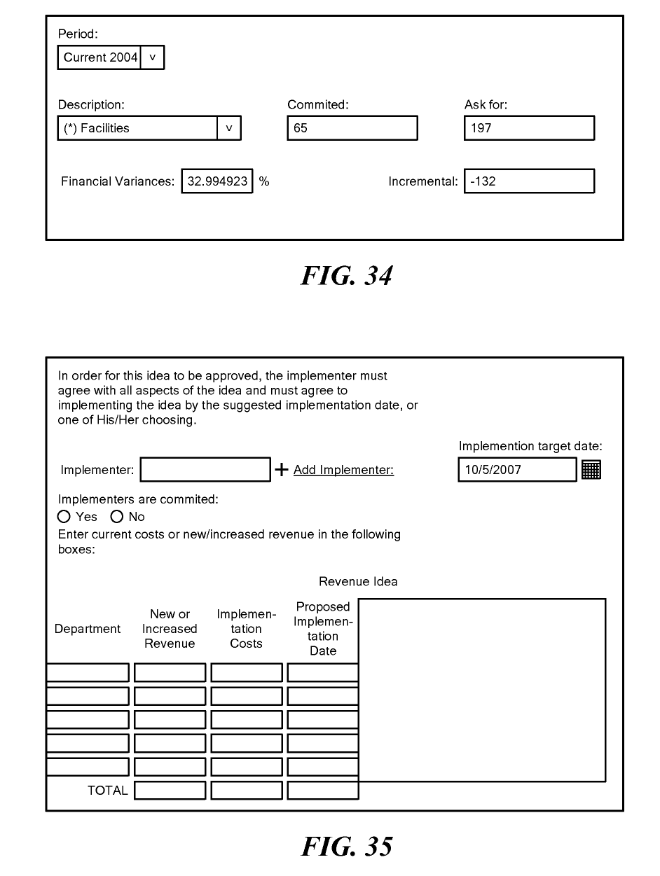

In some embodiments, the implementation web page may also include a financial calculator. FIG. 34 is a representation of a financial web page permitting the manager to calculate financial data. The web page includes a financial calculator that is a pre-programmed calculation template (e.g., similar to an excel document with macros). In some embodiments, the financial calculator is custom to the organization. For example, if the organization has a particular formula or standard for calculating a value (e.g., interest, depreciation, revenue, and cost), the financial calculator can be programmed to automatically calculate the value based on the formula. In the embodiment shown in FIG. 34, the financial calculator provides financial information related to “Facilities” for the year of 2008.

Furthermore, exemplary embodiments of the web page may also include a link to a cost database. In various embodiments, the costs database is similar to the cost data base discussed in relation to FIGS. 17 and 18. The implementation template may also include a currency converter. In some embodiments, the currency convert can convert currency in the cost database, benefits calculator, and/or financial simulator. For example, the currency converter may convert the electricity costs in the cost database from dollars to euros.

FIG. 35 shows another example of the implementation web page. In this example, the manager can select an implementation target date (e.g., the date by which implementation should be completed). The web page also allows the manager to select an implementer for the idea. The manager can select the implementer from a pull-down menu or from a listing of potential implementers. In some embodiments, the implementer can be the same person as the facilitator.

In the embodiment shown in FIG. 35, the implementation web page includes a table with a plurality of fields for entering cost and revenue information. Fields in the department column allow the manager to enter the departments that will be responsible for, or affected by, the implementation of the idea. The manager can also add the implementation costs, new or increased revenue, and/or proposed implementation date for each of the departments. Other fields related to financial and department information can be removed and added depending on the needs of the organization.

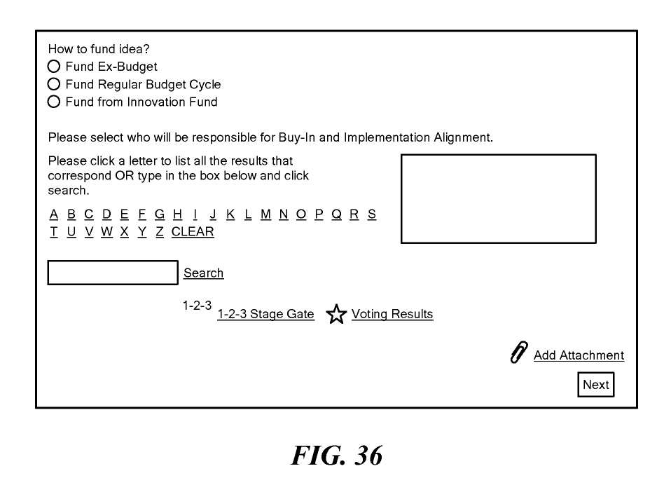

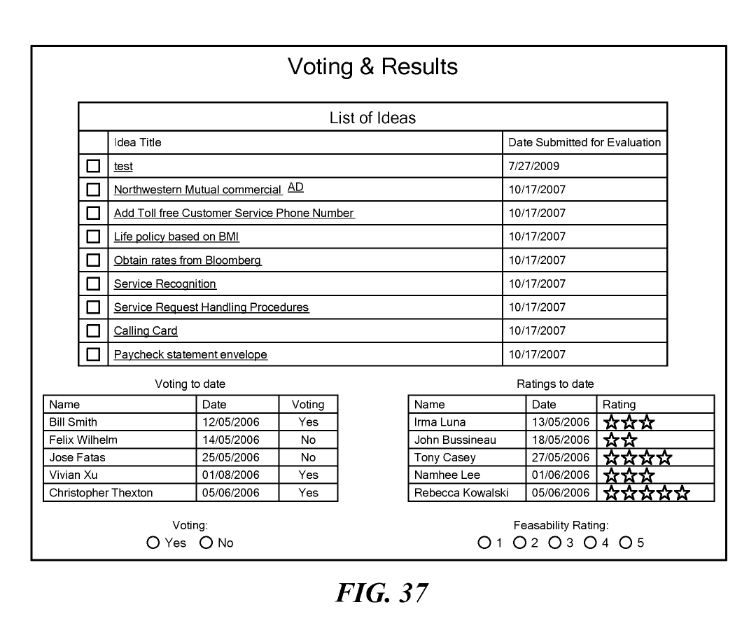

In illustrative embodiments of the invention, the manger can select how to fund the idea. FIG. 36 shows another example of the implementation web page. In this example, the manager can select one of three radio buttons to select how to fund the idea. However, in other embodiments, the web page may include an entry field wherein the manger can enter textual information related to funding. In the embodiment of FIG. 36, the implementation web page also includes fields for searching for and entering the name of a person who will be responsible for buy-in and implementation alignment for the idea. In other words, the manager can select a person who will seek support and help from other people in the organization for implementation of the idea. In various embodiments, the web page may also include a link to another web page which summarizes the voting results for the idea and/or other ideas. FIG. 37 shows an exemplary embodiment of a web page that summarizes the voting results for a plurality of ideas. The radio buttons at the bottom of the page allow the manager to vote on a plurality of submitted ideas.

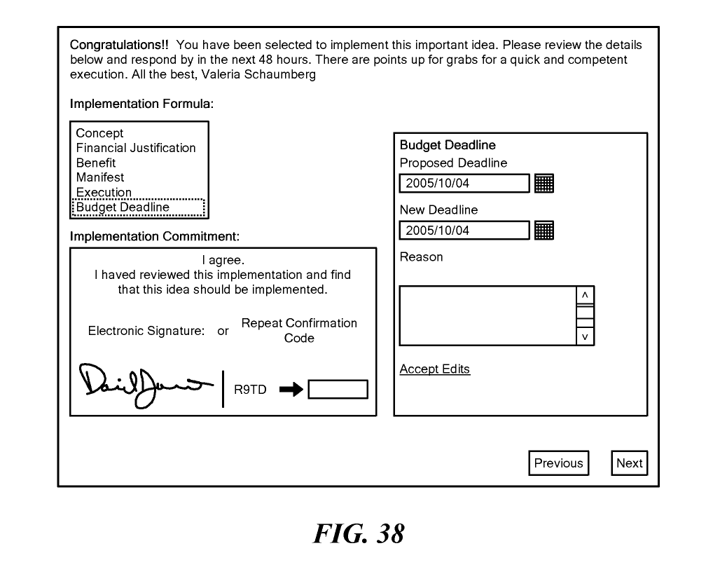

Once the manager completes the web page template, the idea is assigned to the implementer that the manager has selected. FIG. 38 is a representation of a web page permitting the implementer to commit to implementation of the idea. In some embodiments, before committing to the idea, the implementer can review information about the idea and its proposed implementation. By selection from an implementation formula menu, the implementer can view details such as its financial justifications, benefits, manifests, implementation plan, and deadlines. This information is typically entered by, among others, the submitter, the facilitator, and/or the manager as described above with respect to various embodiments of the present invention. In additional or alternative embodiments, the implementer can propose modifying the idea and/or implementation information. For example, in the embodiment shown in FIG. 38, the implementer can propose a new implementation deadline by selecting a new date in the “New Deadline” entry window. The implementer can also provide his reasoning for the new deadline in the “Reason” entry window. This proposed deadline will then be web-published to the manager who can either accept or reject the modification. If the implementer agrees with the implementation details, he can commit to implementation by, for example, electronic signature or by entering a confirmation code. In other embodiments, the implementer does not have an opportunity to modify the implementation information for the idea. Instead, the implementer is required to implement the idea as described by management.

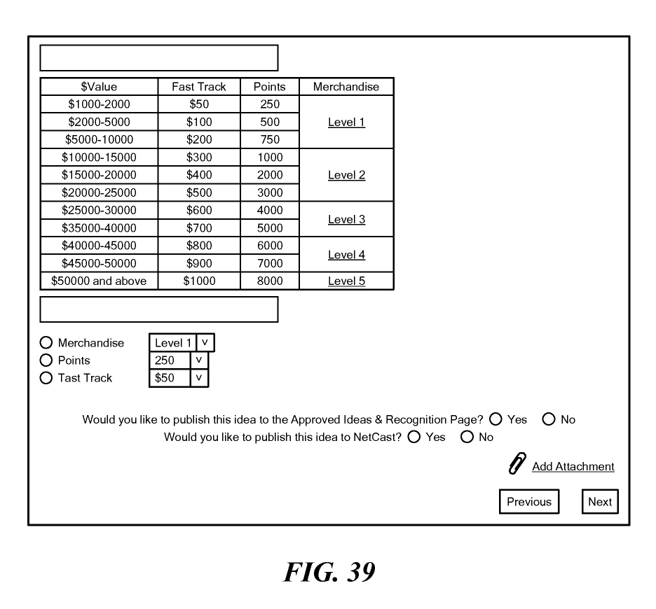

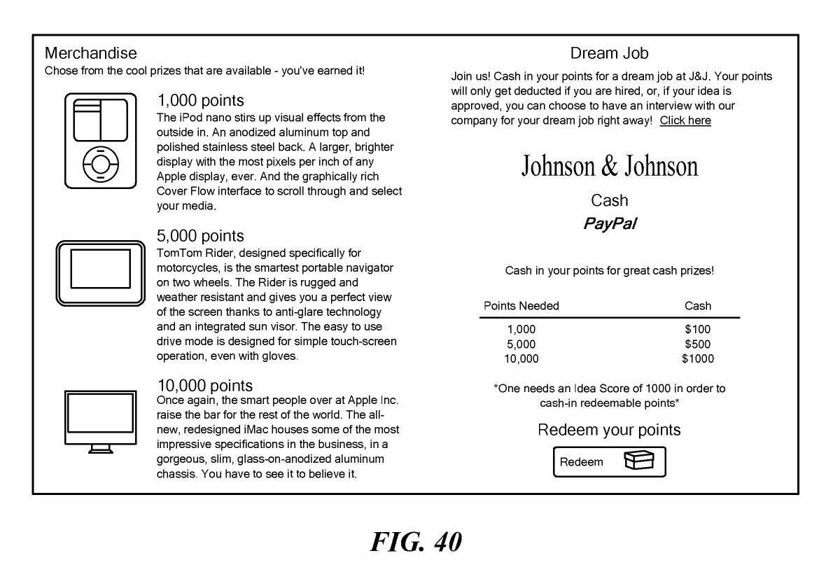

FIG. 39 is a representation of a web page permitting a party to set rewards for ideas. If, for example, the idea is approved for implementation and/or implemented, the party, such as a manger, administrator, or facilitator, can designate a reward for the submitter. The reward may be in the form of points, cash, and/or merchandise. If the submitter is rewarded with points for his idea, he may redeem the points for a cash prize and/or merchandise. FIG. 40 is a representation of a web page that allows the submitter to redeem his points. As can be seen from FIG. 40, with 10,000 points, the submitter can obtain either a computer or a cash prize of $1000. In some cases, the more valuable the idea, the greater the designated reward. The embodiment shown in FIG. 39 allows the party to designate at least one form of reward using three radio buttons. The party can also designate a value for the reward. A reward table helps the party make his selection. In one column, there is a listing of ranges that represent the value of the idea for the organization (e.g., the cost savings or revenue generated by the idea). Based on the value of the idea, the party can select an appropriate cash prize, number of points, and/or merchandise to award the submitter. The reward incentives members of the user community to submit ideas.

In illustrative embodiments of the present invention, rewards such as points, cash prizes, and merchandise may be used as incentives for a number of different people. For example, rewards can be used to motivate submitters, vetters, internal and external facilitators, managers, subject matter experts, and other members of the user community. Members of the user community can be rewarded for, among other things, posting comments on ideas, responding to requests for collaboration, and/or voting (e.g., voting on ideas, comments, or facilitators). Facilitators and implementers may also be rewarded when, for example, they complete a task associated with their idea, or when their idea is approved and/or implemented. In one embodiment, the facilitator has access to a budget of rewards for his assigned idea (e.g., facilitator has 10,000 points he can distribute). Based on the value of a contribution, such as a comment, a response to a collaboration request, and/or response to a question, the facilitator can designate a particular reward to the member who provided the valuable contribution. The system stores and tracks the budget for the rewards and also the rewards that have been designated for each member of the user community.

Also, in the embodiment depicted if FIG. 39, the web page allows the party to web-publish the submitted idea as an implemented and/or approved idea. In other words, the party can post a celebration. The celebration may web-publish the names of the members involved in development and implementation of the idea (e.g., submitter, vetter, facilitator, and/or implementer). In some embodiments, the celebration may also post the rewards that the members received.

In additional or alternative embodiments, there is a limit on the number of pending ideas (e.g., ideas that have not yet been approved and/or implemented) for each member of the community. The limit is web-published to the user community and when a specific member's number of pending idea submissions is within a pre-designated proximity of the limit, the member will be sent an alert. For example, if the limit for pending submissions is five and the member has just submitted an idea, but has two other ideas pending, an may be sent to the member indicating that he may submit up to two additional idea submissions. If one of the user's pending ideas is approved and/or implemented, then another alert may be sent to the member informing him that he has two ideas pending and may submit up to three additional idea submissions. In this manner, illustrative embodiments of the system encourage members to submit only their most promising and best ideas, instead of flooding the system with a large number of idea submissions.

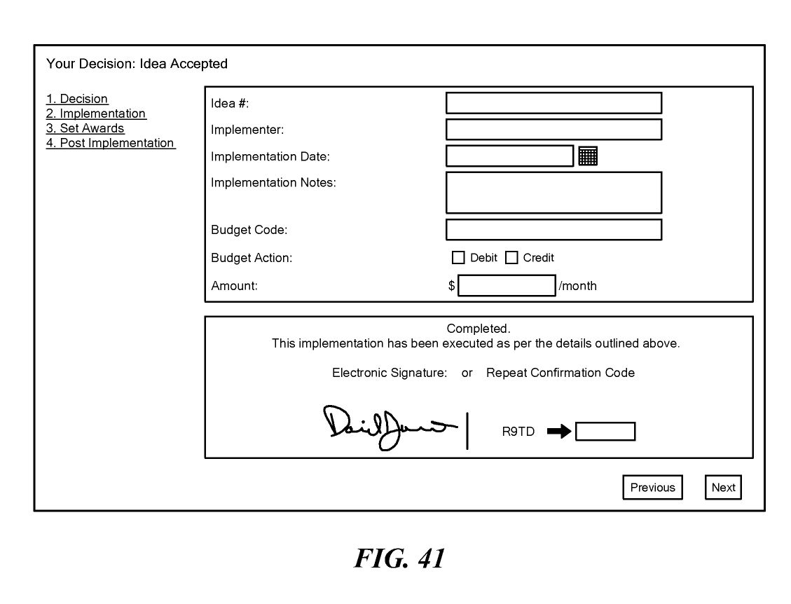

In additional or alternative embodiments, the system may web-publish a confirmation web page that allows the implementer to confirm that the implementation of the idea is complete (e.g., sunset review). Based on the implementation deadline, the system may automatically web publish the confirmation web page to the implementer. For example, if the implementation deadline is Jun. 23, 2010, on Jun. 24, 2010, the day after the deadline, the system may web-publish the confirmation web page to the implementer. In the embodiment shown in FIG. 41, the confirmation web page includes entry windows for an idea identifier, an implementer, an actual implementation date, and notes related to the implementation. In various embodiments, the web page may also include entry windows for modifying the budget. Depending on the implementation costs and maintenance of the idea, the budget for a particular department may be increased or decreased. The implementer can confirm the implementation by, for example, electronic signature and/or by entering a confirmation code.

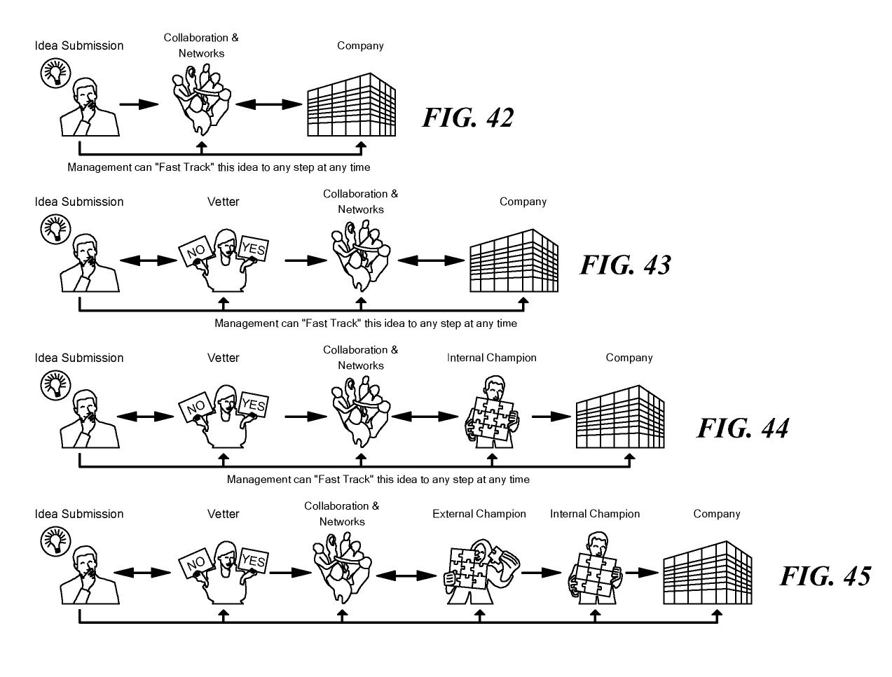

In illustrative embodiment of the invention, the workflow of the system is configurable. In other words, the administrator (and, in some embodiments, a vetter and/or management) can select the tasks and assignments for advancing the idea from submission to implementation. FIGS. 42-45 are examples of workflows in accordance with exemplary embodiments of the present invention. The workflow of FIG. 42 includes idea submission, collaboration, and then evaluation of the idea by management (e.g., voting by management). This workflow does not include a vetter or a facilitator. Such an embodiment of the workflow may be useful if the organization is interested in measuring popularity of the idea without a more detailed development process. On the other hand, FIG. 45 shows a more complex workflow that includes idea submission, a vetter, an external facilitator, an internal facilitator, and evaluation of the idea by management. This embodiment of the workflow may be useful if the organization is interested in more thoroughly developing the idea through collaboration and facilitation. FIGS. 43 and 44 show two other embodiments of a potential workflow. In some embodiments, the administrator can simply select from animations as depicted in FIGS. 42-45 in order to configure the workflow.

In illustrative embodiments of the invention, the administrator can also select the sequence of assignment. For example, the idea may be assigned to an internal facilitator for development of the idea and then may be web-published for collaboration and assigned to an external facilitator. In another example, the submitted idea may first be web-published for collaboration and then assigned to a vetter for vetting. In various embodiments of the invention, the administrator may also select the tasks associated with each assignment. For example, in one workflow, the internal facilitator is only responsible for completing the benefits and documentation tabs for the idea. However, in another workflow, the facilitator may also be responsible for completing the financials and spreadsheet tabs for the implementation. As another example, in some illustrative workflows, management may be responsible for completing the financials tab for the idea.

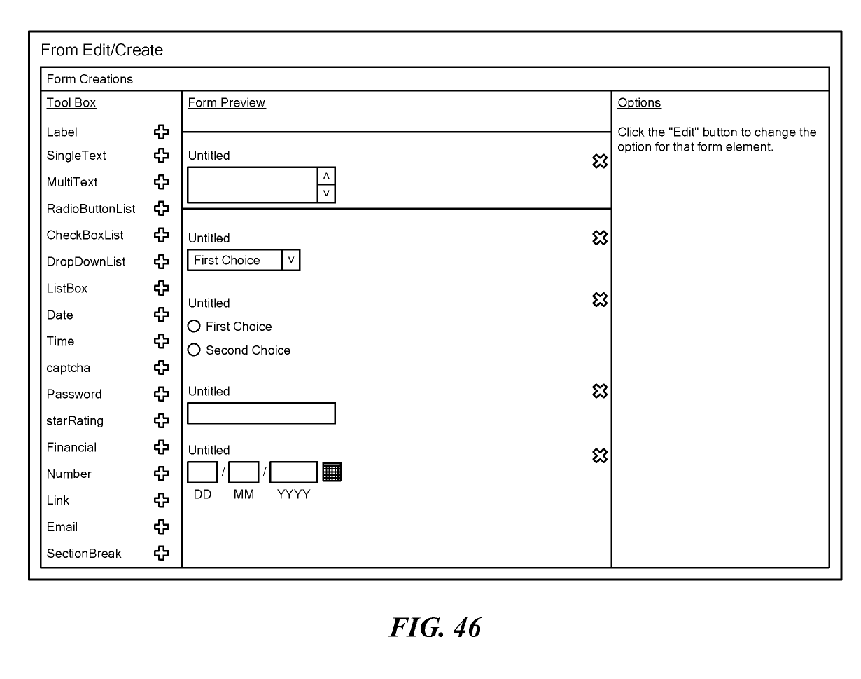

In exemplary embodiments of the present invention, the administrator may configure the workflow by editing and creating new templates. FIG. 46 is a representation of an interface for editing web page templates in accordance with one embodiment of the invention. The administrator and/or management can advantageously remove entry windows and/or tools from the templates by selecting the “x” button associated with the entry window or the tool. To add an entry window or a tool, the administrator can select the “+” button. The administrator may also add a textual title to an entry window or a tool by selecting the untitled header and entering a title. Illustrative embodiments of the interface allow the administrator to create new templates and edit existing templates to better accommodate the development of ideas.

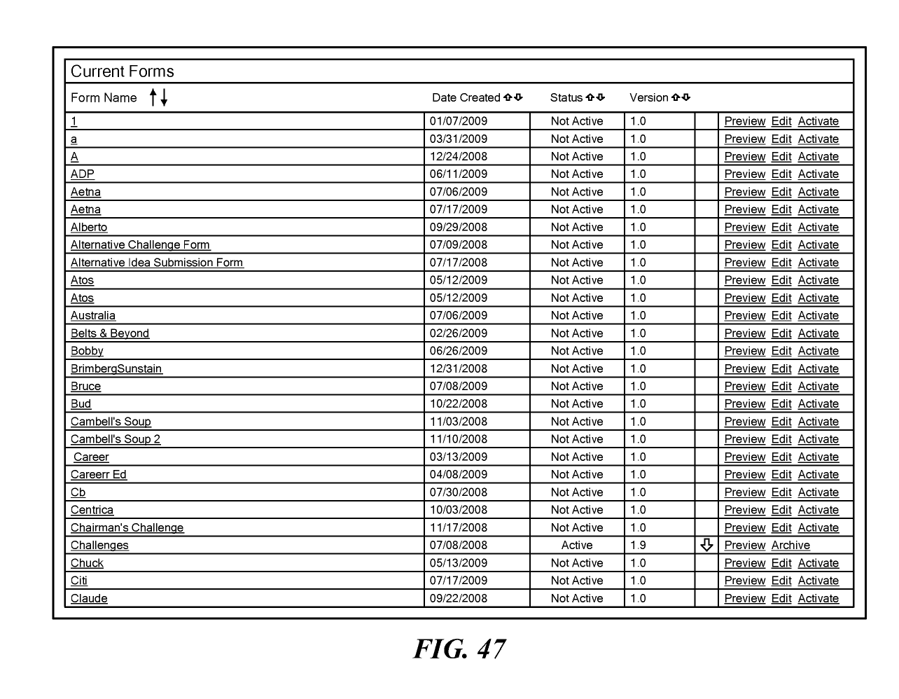

FIG. 47 shows a listing web page that lists a plurality of web page templates in accordance with one embodiment of the invention. This listing webpage allows the administrator to preview and edit templates. If the administrator selects the “Edit” button, the web page links the administrator to an editing interface, such as the one shown in FIG. 46, and the administrator can then edit the particular template. Selection of the “Activate” button will add the webpage template to the workflow. In other words, the user community will be able to access and/or interact with the template. In this manner, the administrator may advantageously control the web page templates that are part of the workflow.

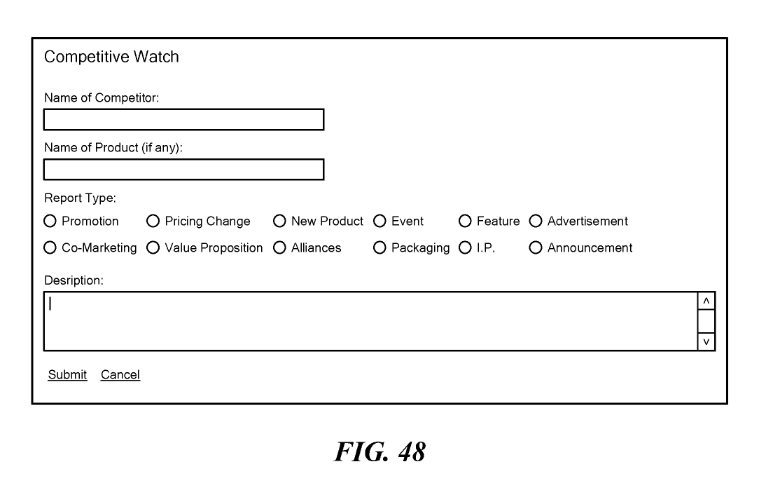

FIG. 48 is a representation of a competitive watch web page permitting members of the user community to enter information related to competitors. In the embodiment of FIG. 48, the competitive watch web page includes entry windows for a name of the competitor, the product, and a description. The web page also includes several radio buttons that describe the report classification. Once the member of the user community completes at least some of the fields, and selects the “Submit” button the idea is web-published to the user community (e.g., managers, facilitators, and/or vetters). Illustrative embodiments of the competitive watch help the organization remain aware of competitor products.

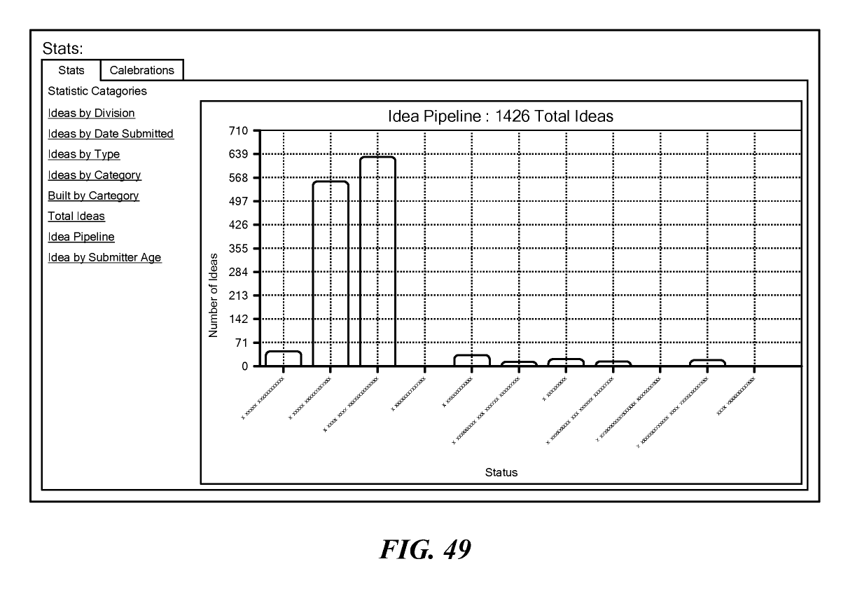

In additional embodiments of the present invention, management may view a visual graphic (e.g., graph, chart, and/or diagram) showing progress of a plurality of ideas through a workflow. FIG. 49 is a representation of an idea pipeline web page displaying progress of a plurality of ideas through a workflow. In the embodiment shown, the visual graphic is a bar graph. The total number of ideas is 1426. According to the visual graphic, nearly 710 ideas have a pending request for collaboration. Exemplary embodiments of the idea pipeline help management see where the bottlenecks are during the idea development process. In another exemplary embodiment, a visual graphic (e.g., graph, chart, and/or diagram) shows progression of a single idea through a workflow. This “timeline” graphic may include several relevant dates. For example, the timeline graphic may include the date the idea was submitted, the date it was vetted, and/or the date it was web-published to members of the user community. In some embodiments, the timeline graphic may also include dates in the future, such an expected management vote and/or an expected deadline for implementation. Illustrative embodiments of the timeline graphic help members quickly ascertain the status of the idea. Furthermore, illustrative embodiments of a bar graphic or other visual graphical may be used to show, for example, which geographic areas of the world idea submissions are being submitted from.

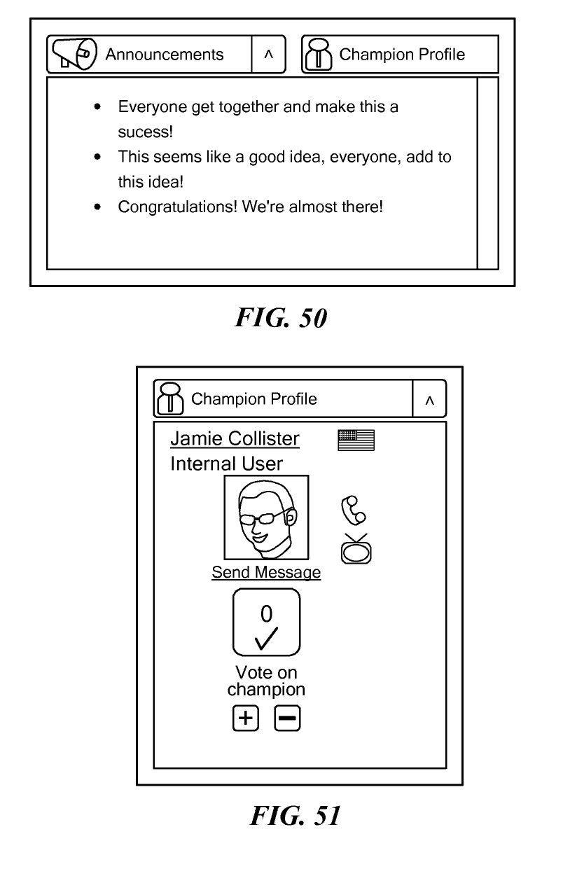

FIG. 50 is a representation of a web page that displays announcements. Various embodiments of the present invention allow the facilitator to make announcements to the members of the community that have access to the idea. For example, in the embodiment shown in FIG. 50, the facilitator encourages members to contribute to the idea. In illustrative embodiments, the members of the community that have access to the idea may also view the facilitator's profile. FIG. 51 is a representation of a web page that displays the facilitator's profile. In some embodiments, the members of the community can vote on the facilitator. A positive vote means that the facilitator has done a good job with the idea and/or other ideas. The facilitator's score gives management a basis for judging the facilitator's performance.

In illustrative embodiments of the present invention, the system publishes a web page to members of the community that helps the members develop and generate ideas (e.g., brain teasers). In some embodiments, the webpage includes a series of questions. The possible questions include inter alia:

Can I do this process better?

How are others (inside and outside the company) doing this process?

Can this process be eliminated? How?

Can this process be done in a different order to improve efficiency?

Is there a better method to accomplishing the task?

Can I eliminate any motions or extra movement? How?

Can I make the work less strenuous? How?

Can I eliminate any paperwork? How?

Can things be saved from another process and used in a different one?

Can I do more of the same tasks at one time?

Is there a way to increase the quality of the work being done?

Is there a less-expensive way to get it accomplished? What is it?

Can a bottleneck be eliminated? How?

Can the task be done faster? How?

Can any duplication of tasks be eliminated?

Can downtime be eliminated or replaced with other tasks?

Can one person do the job as fast as two? How?

Can delays in the process be eliminated?

Is there a better system for doing this task?

Can a workplace be rearranged to increase productivity? How?

Can any steps in a process be combined or eliminated? How?

Could the task be done by customers, suppliers, or someone else instead of employees? How?

Can idle time be used more productively?

In alternative or additional embodiments, the system web-publishes statements for completion that help members develop and generate ideas. The possible statement include inter alia:

I could do my job better if . . .

I wish we could . . .

If we only had . . .

Why don't we try . . .

If I had to do that job I would . . .

This would work better if . . .

Wouldn't it be nice to . . .

This doesn't work well because . . .

Why don't we ever . . .

Other companies are better at this because . . .

In additional or alternative embodiments of the system, a member of the community (e.g., a manager, facilitator, and vetter) may use a cluster tool to associate two separate idea submissions. Illustrative embodiments of the cluster tool, enable the member to associate duplicative and/or related ideas. In some embodiments, to associate ideas, the member may be able to select a first idea in a first entry window and a second idea in a second entry window (and a third idea in a third entry window and so on, in exemplary embodiments). By clicking on a “Cluster” button, the system will automatically associate the first idea and second idea. In some embodiments, the cluster tool associates the ideas by adding a link from the first idea to the second idea. For example, a “Related Idea” button may appear in a listing of ideas (e.g., FIG. 11) and/or the button may appear on an idea web page (e.g., FIG. 12). In this manner, the member may select the button and be directed from the first to the second idea. In other words, the system will web-publish the second idea webpage to the member. In another related embodiment, the cluster tool associates the first and second ideas so that they are developed and processed together. In other words, any information that is added to the first idea submission will be updated in the second idea submission. For example, if the member adds benefit information to the first idea submission, the same benefits information will be added to the second idea submission. In the same manner, if the member uploads a file to the second idea submission, the same file will be uploaded to the first idea submission. In additional or alternative embodiments of the system, the member of the community can de-cluster the idea. In other words, by selection of, for example, a “De-Cluster” button, the member can dissociate the first idea from the second idea submission. In this manner, the system will no longer update information in both of the ideas (e.g., entering information in the first idea will only update the first idea). However, in some embodiments, the information that was previously updated will remain unchanged for each of the first idea and the second idea.

It should be noted that terms such as “terminal” and “server” may be used herein to describe devices that may be used in certain embodiments of the present invention and should not be construed to limit the present invention to any particular device type or system unless the context otherwise requires. Thus, a system may include, without limitation, a client, server, computer, appliance, or other type of device. Such devices (and systems) typically include one or more network interfaces for communicating over a communication network and a processor (e.g., a microprocessor with memory and other peripherals and/or application-specific hardware) configured accordingly to perform device and/or system functions. Computer networks generally may include public and/or private networks; may include local-area, wide-area, metropolitan-area, storage, and/or other types of networks; and may employ communication technologies including, but in no way limited to, analog technologies, digital technologies, optical technologies, wireless technologies (e.g., Bluetooth), networking technologies, and Internetworking technologies.

It should also be noted that systems may use communication protocols and messages (e.g., messages created, transmitted, received, stored, and/or processed by the system), and such messages may be conveyed by a communication network or medium. Unless the context otherwise requires, the present invention should not be construed as being limited to any particular communication message type, communication message format, or communication protocol. Thus, a communication message generally may include, without limitation, a frame, packet, datagram, user datagram, cell, or other type of communication message. Unless the context requires otherwise, references to specific communication protocols are exemplary, and it should be understood that alternative embodiments may, as appropriate, employ variations of such communication protocols (e.g., modifications or extensions of the protocol that may be made from time-to-time) or other protocols either known or developed in the future.

It should also be noted that logic flows may be described herein to demonstrate various aspects of the invention, and should not be construed to limit the present invention to any particular logic flow or logic implementation. The described logic may be partitioned into different logic blocks (e.g., programs, modules, interfaces, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In a typical embodiment of the present invention, predominantly all of the described logic is implemented as a set of computer program instructions that is converted into a computer executable form, stored as such in a computer readable medium, and executed by a microprocessor under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and Internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web) In some embodiments, the computer program may be distributed from a server or electronic bulletin board using a software as a service model (SaaS).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and Internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). Of course, some embodiments of the invention may be implemented as a combination of both software (e.g., a computer program product) and hardware. Still other embodiments of the invention are implemented as entirely hardware, or entirely software.

The present invention may be embodied in other specific forms without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive.

While the invention is described through the above-described exemplary embodiments, it will be understood by those of ordinary skill in the art that modifications to, and variations of, the illustrated embodiments may be made without departing from the inventive concepts disclosed herein. For example, although some aspects of the system have been described with reference to a flowchart, those skilled in the art should readily appreciate that functions, operations, decisions, etc. of all or a portion of each block, or a combination of blocks, of the flowchart may be combined, separated into separate operations or performed in other orders. Moreover, while the embodiments are described in connection with various illustrative data structures, one skilled in the art will recognize that the system may be embodied using a variety of data structures. Furthermore, disclosed aspects, or portions of these aspects, may be combined in ways not listed above. Accordingly, the invention should not be viewed as being limited to the disclosed embodiments.

What is claimed is:

1. A computer-implemented method providing a structured environment for innovation and idea management in an organization, the method comprising:
receiving, over a computer network, and storing an idea submission that includes a description of an idea, from a submitter;
web-publishing, over the network, the idea submission to a set of members of a user community;
receiving, over the network, and storing comments provided by at least one member from the set of members relating to the idea submission;
web-publishing, over the network, the comments to the set of members;
storing, in association with the idea submission, a link to an identifier of a person serving as a facilitator in relation to the idea;
web-publishing, over the network, to the facilitator the idea submission with editing privileges;
web-publishing, over the network, to the facilitator a series of tasks associated with advancing the idea in the organization;
storing data pertaining to completion of each of the series of tasks; and
web-publishing the idea submission and the data over the network to a first set of managers.

2. A method according to claim 1, further comprising web-publishing, over the network, to the facilitator a listing of subject matter experts.

3. A method according to claim 1, further comprising web-publishing, over the network, to the facilitator a set of cost data from a cost database.

4. A method according to claim 3, further comprising web-publishing, over the network, to the facilitator a set of templates through which the facilitator can enter a set of values to calculate cost information for the idea based on the set of cost data.

5. A method according to claim 4, wherein the facilitator can import cost information into the idea submission.

6. A method according to claim 4, further comprising in a computer process, converting a second set of cost data from one currency to another currency.

7. A method according to claim 1, further comprising:
web-publishing, over a network, the comments to the facilitator;
receiving, over the network, from the facilitator via web page interaction a designation of at least one favorable comment; and
web-publishing, over the network, the designation of the at least one favorable comment to the set of members.

8. A method according to claim 1, wherein the facilitator is internal to the organization.

9. A method according to claim 1, wherein the facilitator is external to the organization.

10. A method according to claim 1, further comprising:
receiving from the facilitator over the network via web page interaction a designation that a task associated with advancing the idea in the organization is complete; and
web-publishing, over the network, the designation to a second set of members.

11. A method according to claim 1, further comprising:
web-publishing a scoring template associated with the facilitator, over the network, to a second set of members of the user community;
receiving, over the network, scoring data from the second set of members obtained via web page interaction with the scoring template; and
web-publishing the scoring data to a third set of managers.

12. A method according to claim 1, further comprising automatically performing a search for similar idea submissions in a database of previously submitted idea submissions.

13. A method according to claim 1, further comprising:
awarding points to a member of the community triggered by at least one of
a) receipt of an idea submission;
b) receipt of a comment;
c) completion of a task associated with advancing the idea in the organization;
d) acceptance of an idea; and
e) implementation of an idea submission.

14. A method according to claim 1, further includes web-publishing, over the network, the idea in at least one of eWork and Second Life.

15. A method according to claim 1, further comprising web-publishing, over the network, an announcement to a second set of members of the user community.

16. A method according to claim 1, further comprising:
storing a budget of rewards for the submitted idea;
web-publishing, over the network, to the facilitator the budget of rewards;
web-publishing, over the network, a set of templates wherein the facilitator may allocate rewards to at least one of a second set of members, the submitter, the vetter, and a third set of managers; and
storing a number of allocated rewards for at least one of the second set of members, the submitter, the vetter, and the third set of managers.

17. A method according to claim 1, further comprising web-publishing, over the network, to the facilitator a set of templates through which the facilitator can enter implementation information for the idea.

18. A method according to claim 1, further comprising web-publishing, over the network, to the facilitator a set of templates through which the facilitator can import a spreadsheet for the idea.

19. A method according to claim 1, further comprising web-publishing, over the network, to the facilitator a set of templates through which the facilitator can designate a source of funding for implementation of the idea.

20. A method according to claim 1, further comprising:
web-publishing, over the network, to a second set of members of the user community, a second set of templates through which the second set of members enter competitor related information;
receiving, over the network, the competitor related information; and
web-publishing, over the network, the competitor related information to a third set of members of the user community.

21. A method according to claim 1, further comprising web-publishing, over the network, a set of statements to promote development of a second idea.

22. A method according to claim 1, further comprising web-publishing, over the network, to a second set of members, a timeline for the idea having at least a date of submission for the idea submission.

23. A method according to claim 1, further comprising web-publishing, over the network, a visual graphic showing progress of a plurality of idea submissions through a workflow.

24. A computer-implemented method providing a structured environment for innovation and idea management in an organization, the method comprising:
receiving, over a computer network, and storing an idea submission from a submitter, wherein the idea submission includes a description of an idea;
web-publishing the idea over a network to a vetter;
receiving, over the network, a response to a set of templates, provided over the network to the vetter, the set of templates presenting to the vetter an opportunity to select a scenario for web-publishing of the idea submission from a list of scenarios including:
a) web-publishing of the idea over the network to a set of members in a user community; and
b) withholding web-publishing of the idea over the network to a second set of members of the community; and
processing the idea in accordance with the response.

25. A method according to claim 24, wherein the list of scenarios further includes:
c) web-publishing of the idea over the network to a third set of members both internal and external to the organization;
d) withholding web-publishing of the idea over the network to a fourth set of members of the community external to the organization;
e) web-publishing of the idea over the network to a set of managers; and
f) withholding web-publishing of the idea over the network to a fifth set of members of the community that are exclusive of the set of managers.

26. A computer-implemented method providing a structured environment for innovation and idea management in an organization, the method comprising:
web-publishing, over a computer network, a limit on the number of pending idea submissions over a network to a set of members of a user community;
receiving, over the network, a plurality of idea submissions from a plurality of members of the set of members;
in a computer process, tracking the number of pending idea submissions by each of the plurality of members; and
web-publishing, over the network, an alert to a specific member when the specific member's number of pending idea submissions has reached a pre-designated proximity of the limit.

27. A computer-implemented method providing a structured environment for innovation and idea management in an organization, the method comprising:
receiving, over a computer network, and storing an idea submission that includes a description of an idea, from a submitter;
receiving, over the network, a request for collaboration for the idea from at least one of a facilitator, a vetter, and a first set of managers, the request including identity information identifying a set of members of a user community with whom collaboration is requested;
web-publishing, over the network, the idea to the set of members; and
web-publishing, over the network, the request to the set of members with whom collaboration is requested, the request including a set of templates through which the set of members can comment on the idea.

28. A method according to claim 27, further comprising receiving and web-publishing a plurality of requests to develop an idea team.

29. A computer-implemented method providing a structured environment for innovation and idea management in an organization, the method comprising:
receiving, over a computer network, and storing a first idea submission;
receiving, over the network, and storing a second idea submission;
receiving, over the network, from a member of a user community a set of selections made on a set of templates to cause association of the first and second idea submissions;
in a computer process, associating the first and second idea submissions;
receiving and storing, over a network, first information related to the first idea submission;
updating the second idea submission with the first information; and
web publishing, over the network, the updated second idea submission.

30. A computer-implemented method providing a structured environment for innovation and idea management in an organization, the method comprising:
web-publishing, over a computer network, a set of templates presenting to at least one of an administrator and a set of managers, an opportunity to select at least one scenario for workflow of an idea submission from a list of scenarios including:
a) web-publishing of the idea submission over the network to a set of members of a user community for collaboration;
b) web-publishing and assignment of the idea submission over the network to a vetter for vetting; and
c) web-publishing and assignment of the idea over the network to a facilitator for advancing the idea in the organization;
receiving, over the network, a response to the set of templates;
receiving, over a computer network, and storing an idea submission from a submitter; and
processing the idea submission in accordance with the response to the set of templates.

31. A computer-implemented method providing a structured environment for innovation and idea management in an organization, the method comprising:
storing a plurality of web page templates related to idea submission;
web-publishing, over a network, a set of the web pages templates to an administrator;
providing the administrator with an interface for configuring the set of web page templates; and
web-publishing the configured set of web page templates to a set of members of a user community.

32. A computer-implemented method providing a structured environment for innovation and idea management in an organization, the method comprising:
receiving, over a computer network, and storing an idea submission, the idea submission including a description for an idea;
web-publishing, over a computer network, a first set of templates presenting to at least one of a facilitator and a set of managers an opportunity to select an implementation deadline for the idea;
receiving, over the network, a response to the set of templates including the implementation deadline for the idea; and
based upon the implementation deadline, automatically web-publishing, over a computer network to an implementer, a second set of templates requesting confirmation that the idea has been executed.
